(19) United States
(12) Patent Application Publication
(10) Pub. No.: US 2025/0233686 A1
(43) Pub. Date: Jul. 17, 2025

(54) UPLINK PADDING INDICATION AND FLEXIBLE K2 RANGE

(71) Applicant: QUALCOMM Incorporated, San Diego, CA (US)

(72) Inventors: Ming YANG, San Diego, CA (US); Kausik RAY CHAUDHURI, San Diego, CA (US); Juan MONTOJO, San Diego, CA (US)

(21) Appl. No.: 18/415,471

(22) Filed: Jan. 17, 2024

(51) Int. Cl. H04L 1/00; H04W 72/1268

(52) U.S. Cl. CPC H04L 1/0008; H04W 72/1268

(57) ABSTRACT

Methods, systems, and devices for wireless communications between a user equipment (UE) and network entity are described. The UE may receive, from the network entity, configuration information enabling the UE to report a padding indication pertaining to padding bits the UE inserts and sends in one or more transmissions. The UE may transmit an uplink message and the padding indication according to the configuration information and based on a quantity of padding included by the UE in the uplink message. In some examples, the UE may receive configuration information enabling the UE to apply a flexible time offset between receipt of an uplink grant and transmission of an uplink message. The UE may receive an uplink grant indicating a time offset range defining valid time durations for the flexible time offset. The UE may transmit the uplink message in accordance with the flexible time offset within the time offset range.

### FIELD OF TECHNOLOGY

The following relates to wireless communications, including an uplink padding indication and flexible K2 range.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

UEs may communicate with communication devices, such as network entities. The network entity may communicate various configurations, resource grants, and parameters for communication in the wireless multiple-access communications system.

### SUMMARY

The described techniques relate to improved methods, systems, devices, and apparatuses that support an uplink padding indication and flexible K2 range. For example, the described techniques provide for communications between a user equipment (UE) and a network entity. In some examples relating to the uplink padding indication, the UE may receive, from the network entity, configuration information that enables the UE to report a padding indication that pertains to one or more padding bits the UE inserts and sends in one or more uplink transmissions. The UE may receive a grant that indicates a set of resources for transmission of an uplink message. The UE may transmit the uplink message and the padding indication in accordance with the configuration information and based on a quantity of padding included by the UE in the uplink message. In some examples, the padding indication may be included in the uplink message, or may be indicated separately. The network entity may receive the padding indication and adjust future uplink grants accordingly.

In some examples relating to the flexible K2 range, the UE may receive, from the network entity, configuration information that enables the UE to apply a flexible time offset between receipt of an uplink grant and transmission of an uplink message associated with the uplink grant. The UE may receive the uplink grant that indicates resources for transmission of the uplink message, where the uplink grant also indicates a time offset range that defines valid time durations for the flexible time offset. The UE may transmit the uplink message in accordance with the flexible time offset that is within the time offset range. The network entity may receive the uplink message, and schedule any unused slots.

A method for wireless communications by a UE is described. The method may include receiving configuration information that enables the UE to report a padding indication that pertains to one or more padding bits the UE inserts and sends in one or more uplink transmissions, receiving a grant that indicates a set of resources for transmission of an uplink message by the UE, transmitting the uplink message, and transmitting the padding indication in accordance with the configuration information and based on a quantity of padding included by the UE in the uplink message.

A UE for wireless communications is described. The UE may include one or more memories storing processor executable code, and one or more processors coupled with the one or more memories. The one or more processors may individually or collectively operable to execute the code to cause the UE to receive configuration information that enables the UE to report a padding indication that pertains to one or more padding bits the UE inserts and sends in one or more uplink transmissions, receive a grant that indicates a set of resources for transmission of an uplink message by the UE, transmit the uplink message, and transmit the padding indication in accordance with the configuration information and based on a quantity of padding included by the UE in the uplink message.

Another UE for wireless communications is described. The UE may include means for receiving configuration information that enables the UE to report a padding indication that pertains to one or more padding bits the UE inserts and sends in one or more uplink transmissions, means for receiving a grant that indicates a set of resources for transmission of an uplink message by the UE, means for transmitting the uplink message, and means for transmitting the padding indication in accordance with the configuration information and based on a quantity of padding included by the UE in the uplink message.

A non-transitory computer-readable medium storing code for wireless communications is described. The code may include instructions executable by one or more processors to receive configuration information that enables the UE to report a padding indication that pertains to one or more padding bits the UE inserts and sends in one or more uplink transmissions, receive a grant that indicates a set of resources for transmission of an uplink message by the UE, transmit the uplink message, and transmit the padding indication in accordance with the configuration information and based on a quantity of padding included by the UE in the uplink message.

Some examples of the method, UEs, and non-transitory computer-readable medium described herein may further include operations, features, means, or instructions for transmitting a padding indication capability indicating that the UE may be capable of reporting the padding indication.

Some examples of the method, UEs, and non-transitory computer-readable medium described herein may further include operations, features, means, or instructions for receiving a padding indication capability request, where the transmission of the padding indication capability may be based on receiving the padding indication capability request.

In some examples of the method, UEs, and non-transitory computer-readable medium described herein, transmitting the padding indication may include operations, features, means, or instructions for transmitting an indicator of a percentage of the uplink message or of a payload of the uplink message occupied by the padding.

In some examples of the method, UEs, and non-transitory computer-readable medium described herein, transmitting the padding indication may include operations, features, means, or instructions for transmitting an indicator of a percentage range of the uplink message or of a payload of the uplink message occupied by the padding.

In some examples of the method, UEs, and non-transitory computer-readable medium described herein, transmitting the padding indication may include operations, features, means, or instructions for transmitting an indicator that the quantity of padding included in the uplink message satisfies a threshold.

In some examples of the method, UEs, and non-transitory computer-readable medium described herein, satisfaction of the threshold includes an amount of data for the transmission of the uplink message that may be less than a UE buffer threshold.

In some examples of the method UEs, and non-transitory computer-readable medium described herein, satisfaction of the threshold includes an amount of data for the transmission of the uplink message that may be more than a UE buffer threshold.

Some examples of the method, UEs, and non-transitory computer-readable medium described herein may further include operations, features, means, or instructions for receiving one or more future uplink grants, where the one or more future uplink grants may be adjusted based on the padding indication.

A method for wireless communications by a network entity is described. The method may include transmitting configuration information that enables a UE to report a padding indication that pertains to one or more padding bits included by the UE in one or more uplink transmissions, transmitting a grant that indicates a set of resources for transmission of an uplink message by the UE, receiving the uplink message, and receiving the padding indication in accordance with the configuration information and based on a quantity of padding included by the UE in the uplink message.

A network entity for wireless communications is described. The network entity may include one or more memories storing processor executable code, and one or more processors coupled with the one or more memories. The one or more processors may individually or collectively operable to execute the code to cause the network entity to transmit configuration information that enables a UE to report a padding indication that pertains to one or more padding bits included by the UE in one or more uplink transmissions, transmit a grant that indicates a set of resources for transmission of an uplink message by the UE, receive the uplink message, and receive the padding indication in accordance with the configuration information and based on a quantity of padding included by the UE in the uplink message.

Another network entity for wireless communications is described. The network entity may include means for transmitting configuration information that enables a UE to report a padding indication that pertains to one or more padding bits included by the UE in one or more uplink transmissions, means for transmitting a grant that indicates a set of resources for transmission of an uplink message by the UE, means for receiving the uplink message, and means for receiving the padding indication in accordance with the configuration information and based on a quantity of padding included by the UE in the uplink message.

A non-transitory computer-readable medium storing code for wireless communications is described. The code may include instructions executable by one or more processors to transmit configuration information that enables a UE to report a padding indication that pertains to one or more padding bits included by the UE in one or more uplink transmissions, transmit a grant that indicates a set of resources for transmission of an uplink message by the UE, receive the uplink message, and receive the padding indication in accordance with the configuration information and based on a quantity of padding included by the UE in the uplink message.

Some examples of the method, network entities, and non-transitory computer-readable medium described herein may further include operations, features, means, or instructions for receiving a padding indication capability indicating that the UE may be capable of reporting the padding indication.

Some examples of the method, network entities, and non-transitory computer-readable medium described herein may further include operations, features, means, or instructions for transmitting a padding indication capability request, where reception of the padding indication capability may be based on transmitting the padding indication capability request.

In some examples of the method, network entities, and non-transitory computer-readable medium described herein, receiving the padding indication may include operations, features, means, or instructions for receiving an indicator of a percentage of the uplink message or of a payload of the uplink message occupied by the padding.

In some examples of the method, network entities, and non-transitory computer-readable medium described herein, receiving the padding indication may include operations, features, means, or instructions for receiving an indicator of a percentage range of the uplink message or of a payload of the uplink message occupied by the padding.

In some examples of the method, network entities, and non-transitory computer-readable medium described herein, receiving the padding indication may include operations, features, means, or instructions for receiving an indicator that the quantity of padding included in the uplink message satisfies a threshold.

In some examples of the method, network entities, and non-transitory computer-readable medium described herein, satisfaction of the threshold includes the UE having an amount of data that may be less than a UE buffer threshold.

In some examples of the method, network entities, and non-transitory computer-readable medium described herein, satisfaction of the threshold includes the UE having an amount of data that may be more than a UE buffer threshold.

Some examples of the method, network entities, and non-transitory computer-readable medium described herein may further include operations, features, means, or instructions for adjusting one or more future uplink grants based on the padding indication of the user equipment.

Some examples of the method, network entities, and non-transitory computer-readable medium described herein may further include operations, features, means, or instructions for adjusting the one or more future uplink grants includes adjusting transport block size via a modulation and coding scheme, physical resource block size, physical resource block allocation, allocation of layers, skipping of a scheduled uplink grant, or a combination thereof.

A method for wireless communications by a UE is described. The method may include receiving configuration information that enables the UE to apply a flexible time offset (e.g., flexible K2 range) between receipt of an uplink grant and transmission of an uplink message associated with the uplink grant, receiving the uplink grant that indicates resources for transmission of the uplink message, where the uplink grant also indicates a time offset range that defines valid time durations for the flexible time offset, and transmitting the uplink message in accordance with the flexible time offset that is within the time offset range.

A UE for wireless communications is described. The UE may include one or more memories storing processor executable code, and one or more processors coupled with the one or more memories. The one or more processors may individually or collectively operable to execute the code to cause the UE to receive configuration information that enables the UE to apply a flexible time offset between receipt of an uplink grant and transmission of an uplink message associated with the uplink grant, receive the uplink grant that indicates resources for transmission of the uplink message, where the uplink grant also indicates a time offset range that defines valid time durations for the flexible time offset, and transmit the uplink message in accordance with the flexible time offset that is within the time offset range.

Another UE for wireless communications is described. The UE may include means for receiving configuration information that enables the UE to apply a flexible time offset between receipt of an uplink grant and transmission of an uplink message associated with the uplink grant, means for receiving the uplink grant that indicates resources for transmission of the uplink message, where the uplink grant also indicates a time offset range that defines valid time durations for the flexible time offset, and means for transmitting the uplink message in accordance with the flexible time offset that is within the time offset range.

A non-transitory computer-readable medium storing code for wireless communications is described. The code may include instructions executable by one or more processors to receive configuration information that enables the UE to apply a flexible time offset between receipt of an uplink grant and transmission of an uplink message associated with the uplink grant, receive the uplink grant that indicates resources for transmission of the uplink message, where the uplink grant also indicates a time offset range that defines valid time durations for the flexible time offset, and transmit the uplink message in accordance with the flexible time offset that is within the time offset range.

Some examples of the method, UEs, and non-transitory computer-readable medium described herein may further include operations, features, means, or instructions for transmitting a flexible time offset capability indicating that the UE may be capable of applying the flexible time offset.

Some examples of the method, UEs, and non-transitory computer-readable medium described herein may further include operations, features, means, or instructions for receiving a flexible time offset capability request, where the transmission of the flexible time offset capability may be based on receiving the flexible time offset capability request.

Some examples of the method, UEs, and non-transitory computer-readable medium described herein may further include operations, features, means, or instructions for receiving an additional uplink grant scheduling one or more unused uplink slots of the time offset range and transmitting an additional uplink message in accordance with the additional uplink grant in the one or more unused uplink slots.

Some examples of the method, UEs, and non-transitory computer-readable medium described herein may further include operations, features, means, or instructions for transmitting an indication of a preferred flexible time offset range.

A method for wireless communications by a network entity is described. The method may include transmitting configuration information that enables a UE to apply a flexible time offset between receipt of an uplink grant and transmission of an uplink message associated with the uplink grant, transmitting the uplink grant that indicates resources for transmission of the uplink message, where the uplink grant also indicates a time offset range that defines valid time durations for the flexible time offset, and receiving the uplink message in accordance with the flexible time offset that is within the time offset range.

A network entity for wireless communications is described. The network entity may include one or more memories storing processor executable code, and one or more processors coupled with the one or more memories. The one or more processors may individually or collectively operable to execute the code to cause the network entity to transmit configuration information that enables a UE to apply a flexible time offset between receipt of an uplink grant and transmission of an uplink message associated with the uplink grant, transmit the uplink grant that indicates resources for transmission of the uplink message, where the uplink grant also indicates a time offset range that defines valid time durations for the flexible time offset, and receive the uplink message in accordance with the flexible time offset that is within the time offset range.

Another network entity for wireless communications is described. The network entity may include means for transmitting configuration information that enables a UE to apply a flexible time offset between receipt of an uplink grant and transmission of an uplink message associated with the uplink grant, means for transmitting the uplink grant that indicates resources for transmission of the uplink message, where the uplink grant also indicates a time offset range that defines valid time durations for the flexible time offset, and means for receiving the uplink message in accordance with the flexible time offset that is within the time offset range.

A non-transitory computer-readable medium storing code for wireless communications is described. The code may include instructions executable by one or more processors to transmit configuration information that enables a UE to apply a flexible time offset between receipt of an uplink grant and transmission of an uplink message associated with the uplink grant, transmit the uplink grant that indicates resources for transmission of the uplink message, where the uplink grant also indicates a time offset range that defines valid time durations for the flexible time offset, and receive the uplink message in accordance with the flexible time offset that is within the time offset range.

Some examples of the method, network entities, and non-transitory computer-readable medium described herein may further include operations, features, means, or instructions for receiving a flexible time offset capability indicating that the UE may be capable of applying the flexible time offset.

Some examples of the method, network entities, and non-transitory computer-readable medium described herein may further include operations, features, means, or instructions for transmitting a flexible time offset capability request, where the transmission of the flexible time offset capability may be based on receiving the flexible time offset capability request.

Some examples of the method, network entities, and non-transitory computer-readable medium described herein may further include operations, features, means, or instructions for receiving an indication of a preferred flexible time offset range.

Some examples of the method, network entities, and non-transitory computer-readable medium described herein may further include operations, features, means, or instructions for transmitting an additional uplink grant scheduling one or more unused uplink slots of the time offset range and receiving an additional uplink message in accordance with the additional uplink grant in the one or more unused uplink slots.

### BRIEF DESCRIPTION OF THE DRAWINGS

FIG. 1 shows an example of a wireless communications system that supports an uplink padding indication and flexible K2 range in accordance with one or more aspects of the present disclosure.

FIG. 2 shows an example of a wireless communications system that supports the uplink padding indication and flexible K2 range in accordance with one or more aspects of the present disclosure.

FIG. 3 shows an example of a process flow diagram that supports the uplink padding indication and flexible K2 range in accordance with one or more aspects of the present disclosure.

FIG. 4 shows an example of a wireless communications system that supports the uplink padding indication and flexible K2 range in accordance with one or more aspects of the present disclosure.

FIG. 5 shows an example of a process flow diagram that supports the uplink padding indication and flexible K2 range in accordance with one or more aspects of the present disclosure.

FIGS. 6 and 7 show block diagrams of devices that support the uplink padding indication and flexible K2 range in accordance with one or more aspects of the present disclosure.

FIG. 8 shows a block diagram of a communications manager that supports the uplink padding indication and flexible K2 range in accordance with one or more aspects of the present disclosure.

FIG. 9 shows a diagram of a system including a device that supports the uplink padding indication and flexible K2 range in accordance with one or more aspects of the present disclosure.

FIGS. 10 and 11 show block diagrams of devices that support the uplink padding indication and flexible K2 range in accordance with one or more aspects of the present disclosure.

FIG. 12 shows a block diagram of a communications manager that supports the uplink padding indication and flexible K2 range in accordance with one or more aspects of the present disclosure.

FIG. 13 shows a diagram of a system including a device that supports the uplink padding indication and flexible K2 range in accordance with one or more aspects of the present disclosure.

FIGS. 14 through 21 show flowcharts illustrating methods that support the uplink padding indication and flexible K2 range in accordance with one or more aspects of the present disclosure.

### DETAILED DESCRIPTION

In some wireless communications systems, a network entity may communicate with one or more user equipments (UEs). The network entity may indicate resources to a UE to use for signaling. In some examples, the resources may be greater than the scheduled transmission. The UE may include additional bits, or padding bits, in the transmission to fill the otherwise unused resources. In some transmissions, the padding bits may be a significant portion of the transmission. Padding bits may result in inefficient communications and use of resources.

Techniques described herein provide for a padding indication, which may result in increased efficiency. The UE may indicate the quantity of padding the UE includes and transmits as part of the uplink transmission. The padding indication may be a quantity, percentage, based on a threshold, or otherwise indicated to the network entity. Prior to transmitting the padding indication, the UE and network entity may exchange communications regarding padding indication capability. After receiving the padding indication, the network entity may adjust future uplink grants. For example, the padding indication may indicate a relatively high quantity of padding bits, and the network entity may adjust allocation to improve efficiency.

In some examples, a network entity may indicate a grant indicating resources for uplink transmissions. After receiving the resources, the UE may be configured with a period of time between receiving resources and transmitting a communication associated with the received resources. For physical uplink shared channel (PUSCH) transmissions, the window of time between receiving resources (e.g., via a downlink control information (DCI)) and the start of the scheduled resources, and thus the transmission, may be referred to as K2. Due to variability in traffic and transmission, the UE may transmit after the K2 time window, resulting in unreliable transmission. However, in some examples, the UE may transmit prior to the end of the K2 time window, resulting in inefficient resource use.

Techniques further describe flexible K2 time window ranges for UE communications. The network entity may inquire of the UE if the UE is capable of supporting a flexible K2 range. The UE may indicate a capability, and in some examples, indicate a preference for the K2 range duration. The network entity may configure the UE to implement a flexible K2 range, and then schedule an uplink transmission with corresponding resources and flexible K2 range. The UE may select a window within the flexible K2 range configured by the network entity and transmit the uplink message within the flexible K2 range. In some examples, the network entity may schedule any unused portions of the flexible K2 range. Implementing a flexible K2 range may result in increased efficiency and reliability of uplink communications.

Aspects of the disclosure are initially described in the context of wireless communications systems and process flow diagrams. Aspects of the disclosure are further illustrated by and described with reference to apparatus diagrams, system diagrams, and flowcharts that relate to uplink padding indication and flexible K2 range.

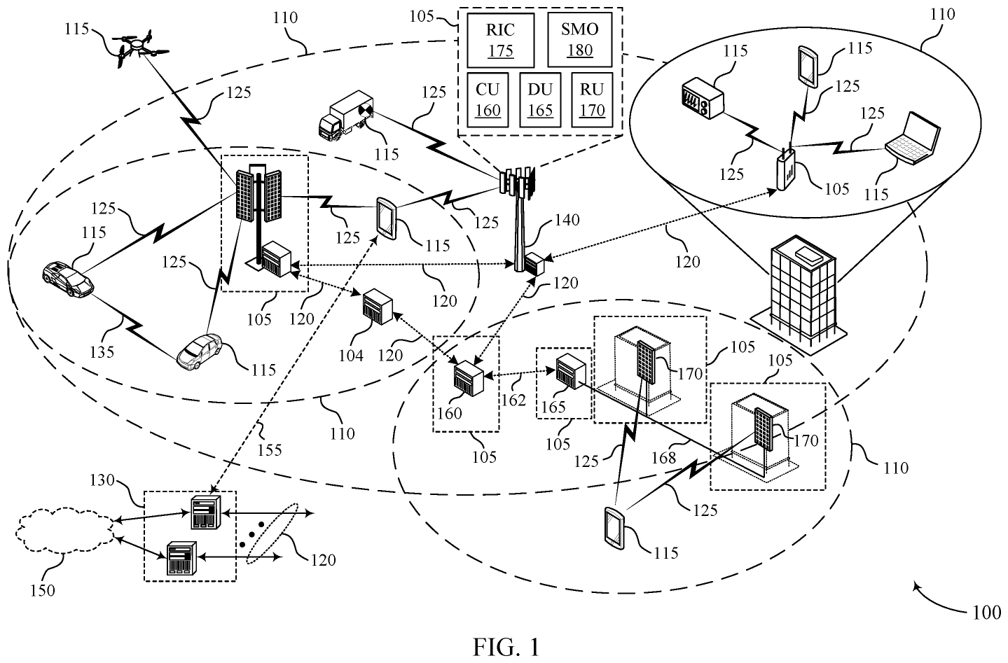

FIG. 1 shows an example of a wireless communications system 100 that supports the uplink padding indication and flexible K2 range in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support uplink padding indication and flexible K2 range as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Ne may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

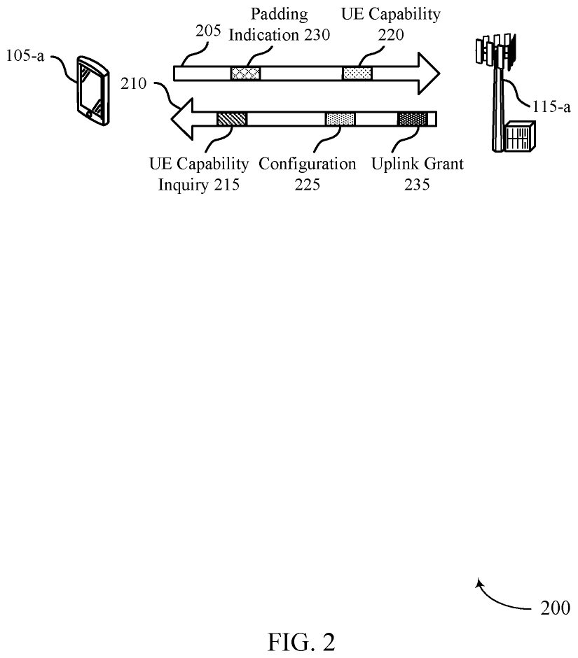

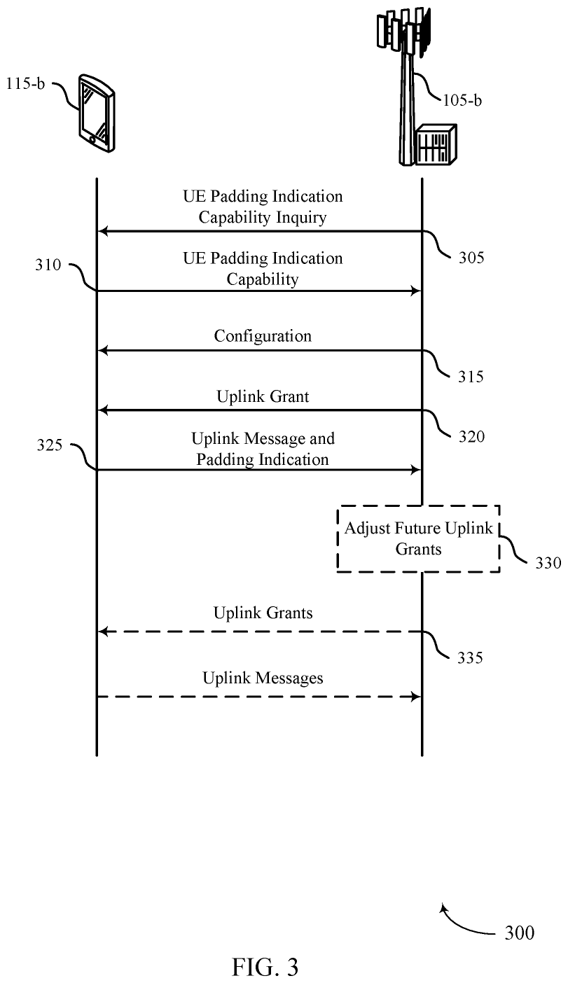

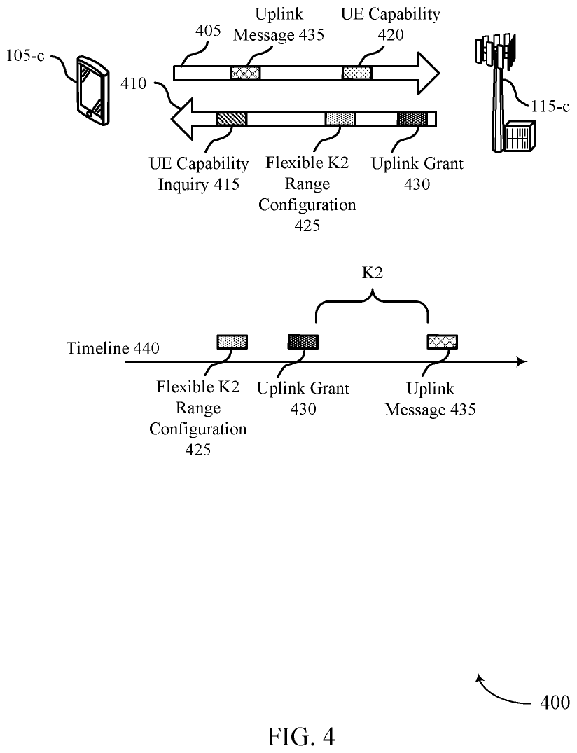

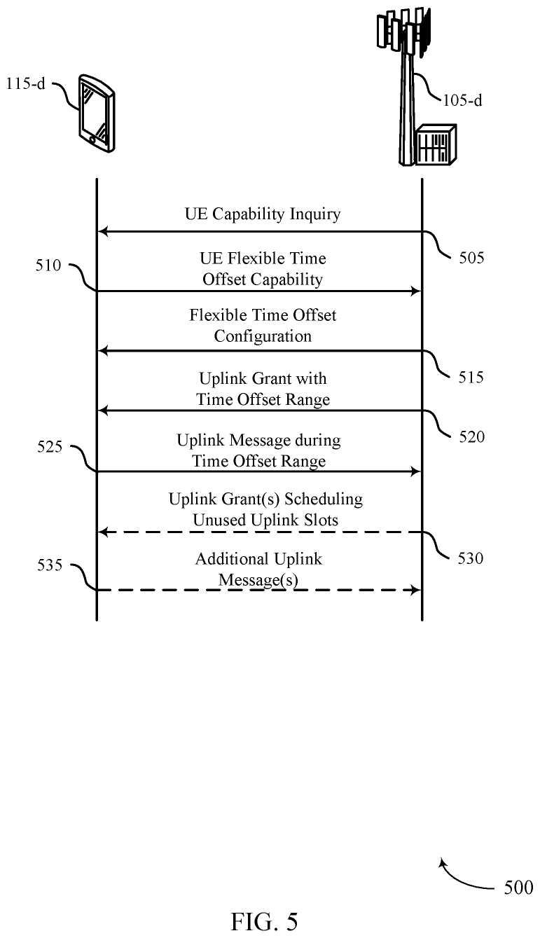

Techniques described herein further relate to an uplink padding indication and flexible K2 range. The UE 115 may receive, from the network entity 105, configuration information and an uplink grant scheduling resources in accordance with the configuration information. The UE 115 may transmit an uplink message in accordance with the uplink grant. In some examples, the configuration information may include a padding indication configuration enabling the UE 115 to indicate a quantity of padding bits included in the uplink message. In some examples, the configuration information may include enabling of the UE 115 to apply a flexible K2 range, or time offset range, to the uplink message. The uplink padding indication may be further described with reference to at least FIG. 2 and FIG. 3, and the flexible K2 range may be further described with reference to at least FIG. 4 and FIG. 5.

FIG. 2 shows an example of a wireless communications system 200 that supports the uplink padding indication and flexible K2 range in accordance with one or more aspects of the present disclosure. The wireless communications system 200 may describe communications between a UE 115-a and a network entity 105-a. The UE 115-a may be an example of the UE 115 as described with reference to FIG. 1, and the network entity 105-a may be an example of the network entity 105 as described with reference to FIG. 1.

The UE 115-a and the network entity 105-a may communicate via a communication link 205 and a communication link 210. The communication link may be an example of an uplink, and the communication link 210 may be an example of a downlink. The UE 115-a may receive a UE capability inquiry 215, transmit a UE capability 220, receive a configuration 225, receive an uplink grant 235, and transmit a padding indication 230. The padding indication 230 may be part of an uplink message, or the UE 115-a may transmit an additional uplink message. In some examples, the network entity may adjust future uplink grants, and transmit the adjusted uplink grants to the UE 115-a. The UE 115-a may transmit additional uplink messages according to the adjusted uplink grants.

In some examples, the network entity 105-a may schedule resources for transmissions of the UE 115-a by transmitting the uplink grant 235. The uplink grant 235 may a scheduling request grant or an uplink pre-scheduling grant. In some examples, the uplink grant 235 may indicate more resources for a transmission than the UE 115-a requires for the transmission. That is, the UE 115-a may have fewer information bits than scheduled resources. For example, the UE 115-a may perform package bundling for UE 115-a power saving, which may result in a fixed transmission size and unused resources. In such examples, the UE 115-a may include additional bits to fill, or pad, the additional unused resources. Such bits may be referred to as padding bits. The UE 115-a may insert one or more padding bits into one or more uplink transmissions, and send the padding bits as part of the transmission.

Some transmissions may have very high padding bit percentages, or a high quantity of padding bits, such as for medium access control (MAC) messages of infrastructure vendors and other organizations. In some examples, messages may include 60-90% padding bits. Including padding bits as part of transmissions may increase uplink interference and increase UE 115-a power consumption. Some techniques may skip uplink transmissions to reduce the transmission of padding bits. However, skipping transmissions may waste resources, such as physical downlink control channel (PDCCH) resources, and result in ambiguity. If a UE 115-a skips a transmission, the network entity 105-a may not be notified as to whether the skipping was related to padding bits or if the uplink scheduling grant was not received.

Techniques described herein provide for a padding indication 230 that indicates to the network entity 105-a the quantity of padding bits of an uplink message. The network entity 105-a may adjust future uplink grants based on the padding indication 230, which may result in power savings at the UE 115-a and increased resource efficiency.

The network entity 105-a may inquire as to the capability of the UE 115-a to transmit a padding indication 230 by transmitting the UE capability inquiry 215. The UE capability inquiry 215 may be a request for the UE 115-a to indicate if the UE 115-a is capability of transmitting the padding indication 230. The UE 115-a may receive the UE capability inquiry 215 and transmit the UE capability 220. The UE capability 220 may indicate to the network entity 105-a that the UE 115-a is capable of transmitting the padding indication 230.

The network entity 105-a may transmit the configuration 225. The configuration 225 may be configuration information that enables the UE 115-a to report the padding indication 230. The padding indication 230 may be, or may be based on, the quantity of padding bits the UE 115-a inserts and sends in one or more uplink transmissions. The network entity 105-a may transmit a grant to the UE 115-a, the uplink grant 235, that indicates a set of resources of the UE 115-a to use for transmitting an uplink message.

The UE 115-a may receive the uplink grant 235, and transmit the uplink message via the resources indicated in the uplink grant 235, the padding indication 230, or both. In some examples, the padding indication 230 may be part of the uplink message (e.g., the uplink message may include the padding indication 230), or the padding indication 230 may be the uplink message or a separate message. For example, the uplink message may include a quantity of padding bits, and the padding indication 230 may indicate the quantity of padding bits the UE 115-a included in the message.

The UE 115-a may be an ambient internet-of-things (IoT) device, such as an energy harvesting-capable device. For example, the UE 115-a may be an ambient IoT device that includes padding bits as part of uplink transmissions. In some examples, the uplink transmissions (e.g., messages) may be channel state information (CSI), MAC control element (CE), or RRC signaling, or a combination thereof.

The padding indication 230 may indicate a quantity of padding bits, a number of padding bits, a payload of padding bits, a percentage of padding bits, a percentage range of padding bits, indicate that the quantity of padding bits satisfies a threshold, or otherwise indicate the quantity of padding bits included in the uplink message. For example, the padding indication 230 may be bits added to the uplink message, where each possibility indicates to the network entity 105-a information about the quantity of padding bits. For example, the padding indication 230 may indicate a specific percentage, such as a two-digit number (e.g., 35, 54, 67, 89).

In some examples, the padding indication 230 may include bits that indicate a range, such as: the sequence 00 may indicate a padding range of 0-25%, the bit sequence 01 may indicate a padding range of 25-50%, etc. In some examples, the padding indication 230 may indicate that the quantity of padding satisfied a threshold. For example, a threshold may be indicated as part of the configuration 225, or otherwise indicated to the UE 115-a. The threshold may be that the UE 115-a indicates if the proportion of padding bits exceeds a threshold, such as 70%. In some examples, the threshold may be based on the amount of uplink data in the UE 115-a buffer. For example, if there is a high amount of data for transmission in the uplink message that exceeds the threshold, the UE 115-a may indicate that the uplink transmission has a high percent padding. In another example, if there is a low amount of data and does not exceed the threshold, the UE 115-a may indicate that the uplink transmission has a low percept padding. In some examples, the configuration 225 may indicate a periodicity for the UE 115-a to transmit the padding indication 230, as well as a format.

The network entity 105-a may adjust future uplink grants based on the padding indication 230. For example, the network entity may adjust transport block size, physical resource block (PRB) parameters (e.g., size, allocation), and layer allocation. Adjusting future uplink grants may include adjusting transport block size via an updated modulation and coding scheme, or by skipping a scheduled uplink grant. For example, the network entity 105-a may determine to indicate to the UE 115-a to skip transmission of a future scheduled uplink message, or the network entity 105-a may skip the transmission of a future uplink grant. The padding indication 230 and adjusted uplink grants may also apply to prescheduled uplink grant applications. For example, if the UE 115-a indicates a high quantity of padding, the network entity 105-a may reduce transport block size. The UE 115-a may receive the adjusted uplink grants and transmit future uplink transmission accordingly. Such techniques may reduce the waste of resources and increase efficiency.

FIG. 3 shows an example of a process flow diagram 300 that supports the uplink padding indication and flexible K2 range in accordance with one or more aspects of the present disclosure. The process flow diagram 300 may describe communications relating to the uplink padding indication between a UE 115-b and a network entity 105-b. The UE 115-a may be an example of the UE 115 as described with reference to FIG. 1, and the network entity 105-b may be an example of the network entity 105 as described with reference to FIG. 1.

In the description and illustration of the process flow diagram 300, the operations between the UE 115-b and the network entity 105-b may be performed in different orders or at different times. Some operations may also be left out of the process flow diagram 300, or other operations may be added. Although the UE 115-b and the network entity 105-b are shown performing the operations of the process flow diagram 300, some aspects of some operations may also be performed by one or more other wireless devices.

At 305, the UE 115-b may receive, and the network entity 105-b may transmit, a padding indication capability request. The request may specify that the UE 115-b is to provide capability information to the network entity 105-b. In particular, the request may ask that the UE 115-b provide an indication of whether the UE 115-b is capable of reporting a quantity of padding that the UE 115-b includes in uplink transmissions responsive to uplink grants.

At 310, the UE 115-b may transmit, and the network entity 105-b may receive, a padding indication capability indicating that the UE 115-b is capable of reporting the padding indication. The transmission of the padding indication capability may be based on receiving the padding indication capability request.

At 315, the UE 115-b may receive, and the network entity 105-b may transmit, configuration information that enables the UE 115-b to report a padding indication that pertains to one or more padding bits the UE inserts and sends in one or more uplink transmissions. The configuration information may be in the form of RRC signaling, for example, and may provide values for one or more parameters used by the UE 115-b in the transmission of the padding indication.

At 320, the UE 115-b may receive, and the network entity 105-b may transmit, a grant that indicates a set of resources for transmission of an uplink message by the UE 115-b.

At 325, the UE 115-b may transmit the uplink message, and may transmit the padding indication in accordance with the configuration information and based on a quantity of padding included by the UE 115-b in the uplink message. In some examples, the uplink message and the padding indication may be included in the same message, and in some examples, the padding indication and the uplink message may be different messages.

The padding indication may be an indicator of a percentage of the uplink message or of a payload of the uplink message occupied by the padding. In some examples, the padding indication may be an indicator of a percentage range of the uplink message or of a payload of the uplink message occupied by the padding.

The padding indication may be an indicator that the quantity of padding included in the uplink message satisfies a threshold. The threshold may be satisfied when an amount of data for the transmission of the uplink message is less than a UE 115-b buffer threshold, or the threshold may be satisfied when an amount of data for the transmission of the uplink message is more than a UE 115-b buffer threshold.

At 330, the network entity 105-b may adjust one or more future uplink grants based on the padding indication of the user equipment. Adjusting the one or more future uplink grants may include adjusting transport block size via a modulation and coding scheme, physical resource block size, physical resource block allocation, allocation of layers, skipping of a scheduled uplink grant, or a combination thereof.

At 335, the UE 115-b may receive one or more future uplink grants, where the one or more future uplink grants are adjusted based on the padding indication. Adjustments may include providing less frequent grants or smaller grants, for example.

FIG. 4 shows an example of a wireless communications diagram 400 that supports the uplink padding indication and flexible K2 range in accordance with one or more aspects of the present disclosure. The wireless communications diagram 400 may describe communications between a UE 115-c and a network entity 105-b relating to the flexible K2 range. The UE 115-c may be an example of the UE 115 as described with reference to FIG. 1, and the network entity 105-c may be an example of the network entity 105 as described with reference to FIG. 1.

The UE 115-c and the network entity 105-c may communicate via a communication link 405 and a communication link 410. The communication link 405 may be an example of an uplink, and the communication link 410 may be an example of a downlink. The UE 115-c may receive a UE capability inquiry 415, transmit a UE capability 420, receive a flexible K2 range configuration 425, receive an uplink grant 430 that includes a flexible K2 range, and transmit an uplink message 435.

Uplink communications, or traffic, may vary with respect timing. For example, traffic may arrive earlier or later that a PUSCH transmission occasion indicated by the uplink grant 430. Due to such inconsistencies, the UE 115-c may be configured with an interval between the uplink grant 430 and the PUSCH transmission occasion (e.g., the uplink message 435). As shown with respect to timeline 440, the interval between the uplink grant 430 and the uplink message 435 may be referred to as K2. RRC may define multiple possible K2 values. The K2 value may be indicated by the uplink grant 430, such as part of a DCI. However, due to the variation in traffic, the K2 may be too short, or may be too long, resulting in unnecessary latency.

Techniques described herein provide for a flexible K2 range indicated by the uplink grant for the uplink message 435 (e.g., PUSCH transmission). Rather than indicating a static K2 value, the network entity 105-c may indicate a range of possible K2 values, resulting in a range of time that the UE 115-c may transmit the uplink message 435. The flexible K2 range may also be referred to as a flexible time offset range or a flexible K2. Such techniques may reduce latency and increase traffic reliability and flexibility.

The network entity 105-c may transmit a UE capability inquiry 415 that asks (e.g., inquires) if the UE 115-c is capable of implementing a flexible K2 range. The UE capability inquiry 415 may also be a request that asks the UE 115-c to transmit the UE capability 420. The UE 115-c may transmit a UE capability 420 indicating that the UE 115-c is capable of applying a flexible K2 range.

In response to the UE capability 420, the network entity 105-c may transmit the flexible K2 range configuration 425 and the uplink grant 430. The flexible K2 range configuration 425 may configure the UE 115-d to apply the flexible K2 range between receipt of an uplink grant 430 and transmission of the uplink message 435. The uplink grant 430 may indicate resources for transmission of the uplink message 435. The uplink grant 430 may also indicate a flexible K2 range that defines a range of valid time durations for the K2. In some examples, the flexible K2 range may be indicated as part of the flexible K2 range configuration.

The flexible K2 range may be a range of possible K2 values. In some examples, multiple flexible K2 ranges may be configured by RRC signaling, where each range may have a different index. The uplink grant 430 may configure larger data transmissions with larger varying arrival time intervals with larger flexible K2 ranges, and may configure smaller data transmission with less varying arrival time intervals with smaller flexible K2 ranges. In addition to indicating the index of the flexible K2 range to be applied, the uplink grant 430 may indicate the starting uplink slot of the flexible K2 range, as well as the number of uplink slots.

The network entity 105-c may schedule an uplink message 435 by transmitting the uplink grant 430, enabling the UE 115-c to implement the configured flexible K2 range when transmitting the uplink message 435. For example, the uplink grant 430 may indicate that the UE 115-c may transmit the uplink message 435 within slots 6-10 after the starting slot. The uplink grant 430 may schedule the resources, and the UE 115-c may determine when to transmit the uplink message 435 within slots 6-10.

In some examples, the UE 115-c may indicate a preferred flexible K2 range based on uplink traffic arrival time. The UE 115-c may indicate the preference via RRC, MAC-CE, CSI, or other signaling. In some examples, the preference may be included as part of the UE capability 420. The network entity 105-c may adjust the flexible K2 range accordingly, such as by changing the flexible K2 range configuration 425. In some examples, the network entity 105-c may adjust future uplink grants based on UE preference, the received uplink message 435, or both. For example, the network entity 105-c may receive the uplink message 435 at the lower value of the configured flexible K2 range, and may schedule smaller ranges for future grants.

The network entity 105-c may reschedule unused uplink slots within the flexible K2 range (e.g., time window). For example, if the uplink message 435 is received within the flexible K2 range, the network entity 105-c may reschedule the remaining slots.

FIG. 5 shows an example of a process flow diagram 500 that supports the uplink padding indication and flexible K2 range in accordance with one or more aspects of the present disclosure. The process flow diagram 500 may describe communications relating to the uplink padding indication between a UE 115-d and a network entity 105-d. The UE 115-d may be an example of the UE 115 as described with reference to FIG. 1, and the network entity 105-d may be an example of the network entity 105 as described with reference to FIG. 1. The flexible time offset may be an example of the flexible K2 range as described herein.

In the description and illustration of the process flow diagram 500, the operations between the UE 115-d and the network entity 105-d may be performed in different orders or at different times. Some operations may also be left out of the process flow diagram 500, or other operations may be added. Although the UE 115-d and the network entity 105-d are shown performing the operations of the process flow diagram 500, some aspects of some operations may also be performed by one or more other wireless devices.

At 505, the UE 115-d may receive, and the network entity 105-d may transmit, a flexible time offset (e.g., flexible K2 range) capability request.

At 510, the UE 115-d may transmit, and the network entity 105-d may receive, a flexible time offset capability indicating that the UE 115-d is capable of applying the flexible time offset. The transmission of the flexible time offset capability is based on receiving the flexible time offset capability request.

At 515, the UE 115-d may receive configuration information that enables the UE 115-d to apply a flexible time offset between receipt of an uplink grant and transmission of an uplink message associated with the uplink grant.

At 520, the UE 115-d may receive the uplink grant that indicates resources for transmission of the uplink message, where the uplink grant also indicates a time offset range that defines valid time durations for the flexible time offset.

At 525, the UE 115-d may transmit the uplink message in accordance with the flexible time offset that is within the time offset range.

At 530, the UE 115-d may receive an additional uplink grant (e.g., one or more uplink grants) scheduling one or more unused uplink slots of the time offset range.

At 535, the UE 115-d may transmit an additional uplink message (e.g., one or more additional uplink messages) in accordance with the additional uplink grant in the one or more unused uplink slots.

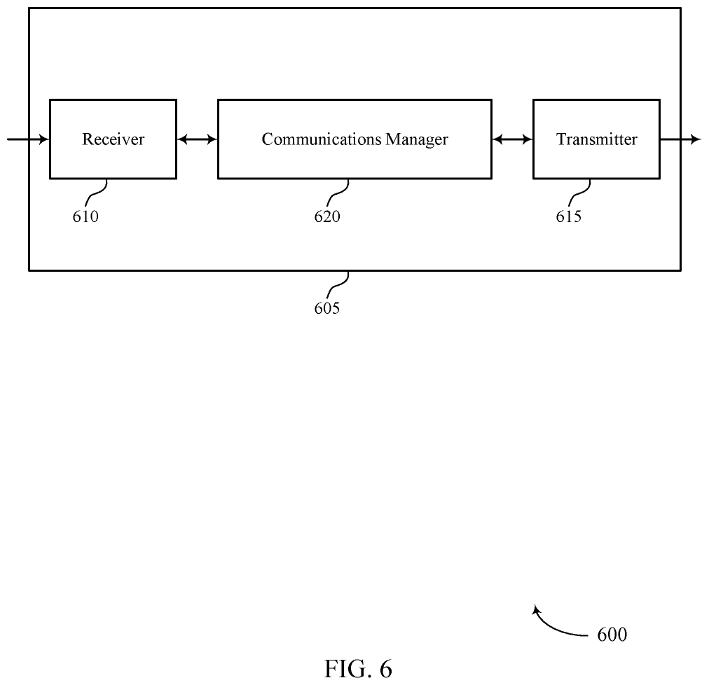

FIG. 6 shows a block diagram 600 of a device 605 that supports the uplink padding indication and flexible K2 range in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to uplink padding indication and flexible K2 range). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to uplink padding indication and flexible K2 range). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of uplink padding indication and flexible K2 range as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor. If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving configuration information that enables the UE to report a padding indication that pertains to one or more padding bits the UE inserts and sends in one or more uplink transmissions. The communications manager 620 is capable of, configured to, or operable to support a means for receiving a grant that indicates a set of resources for transmission of an uplink message by the UE. The communications manager 620 is capable of, configured to, or operable to support a means for transmitting the uplink message. The communications manager 620 is capable of, configured to, or operable to support a means for transmitting the padding indication in accordance with the configuration information and based on a quantity of padding included by the UE in the uplink message.

Additionally, or alternatively, the communications manager 620 may support wireless communications in accordance with examples as disclosed herein. For example, the communications manager 620 is capable of, configured to, or operable to support a means for receiving configuration information that enables the UE to apply a flexible time offset between receipt of an uplink grant and transmission of an uplink message associated with the uplink grant. The communications manager 620 is capable of, configured to, or operable to support a means for receiving the uplink grant that indicates resources for transmission of the uplink message, where the uplink grant also indicates a time offset range that defines valid time durations for the flexible time offset. The communications manager 620 is capable of, configured to, or operable to support a means for transmitting the uplink message in accordance with the flexible time offset that is within the time offset range.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for the uplink padding and flexible K2 range, which may result in various advantages, including, reduced processing, reduced power consumption, more efficient utilization of communication resources, among other advantages.

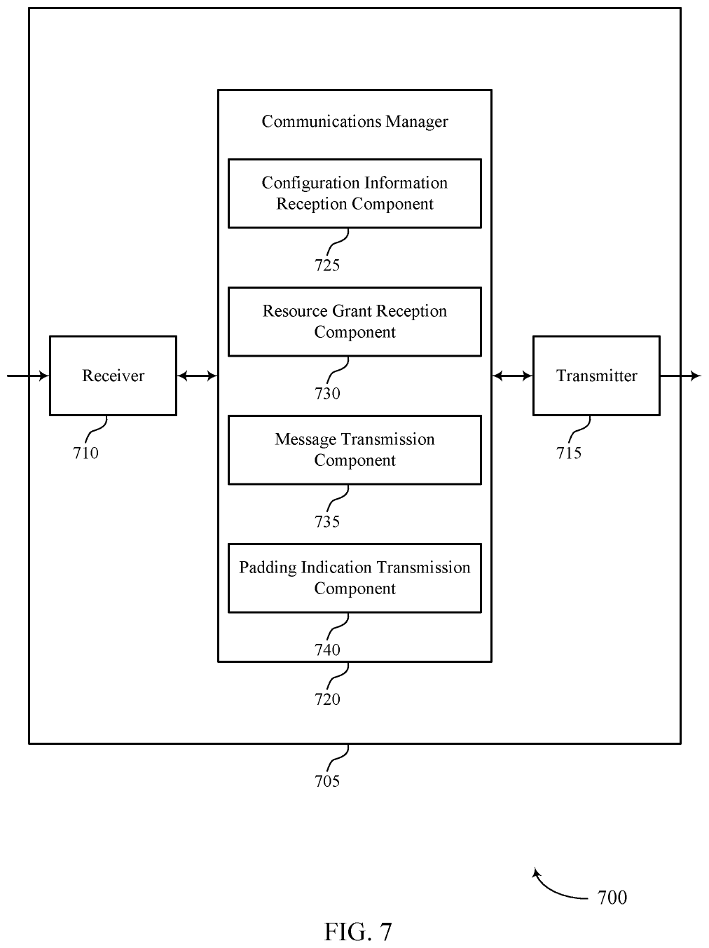

FIG. 7 shows a block diagram 700 of a device 705 that supports the uplink padding indication and flexible K2 range in accordance with one or more aspects of the present disclosure. The device 705 may be an example of aspects of a device 605 or a UE 115 as described herein. The device 705 may include a receiver 710, a transmitter 715, and a communications manager 720. The device 705, or one of more components of the device 705 (e.g., the receiver 710, the transmitter 715, and the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to uplink padding indication and flexible K2 range). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to uplink padding indication and flexible K2 range). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of uplink padding indication and flexible K2 range as described herein. For example, the communications manager 720 may include a configuration information reception component 725, a resource grant reception component 730, a message transmission component 735, a padding indication transmission component 740, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The configuration information reception component 725 is capable of, configured to, or operable to support a means for receiving configuration information that enables the UE to report a padding indication that pertains to one or more padding bits the UE inserts and sends in one or more uplink transmissions. The resource grant reception component 730 is capable of, configured to, or operable to support a means for receiving a grant that indicates a set of resources for transmission of an uplink message by the UE. The message transmission component 735 is capable of, configured to, or operable to support a means for transmitting the uplink message. The padding indication transmission component 740 is capable of, configured to, or operable to support a means for transmitting the padding indication in accordance with the configuration information and based on a quantity of padding included by the UE in the uplink message.

Additionally, or alternatively, the communications manager 720 may support wireless communications in accordance with examples as disclosed herein. The configuration information reception component 725 is capable of, configured to, or operable to support a means for receiving configuration information that enables the UE to apply a flexible time offset between receipt of an uplink grant and transmission of an uplink message associated with the uplink grant. The resource grant reception component 730 is capable of, configured to, or operable to support a means for receiving the uplink grant that indicates resources for transmission of the uplink message, where the uplink grant also indicates a time offset range that defines valid time durations for the flexible time offset. The message transmission component 735 is capable of, configured to, or operable to support a means for transmitting the uplink message in accordance with the flexible time offset that is within the time offset range.

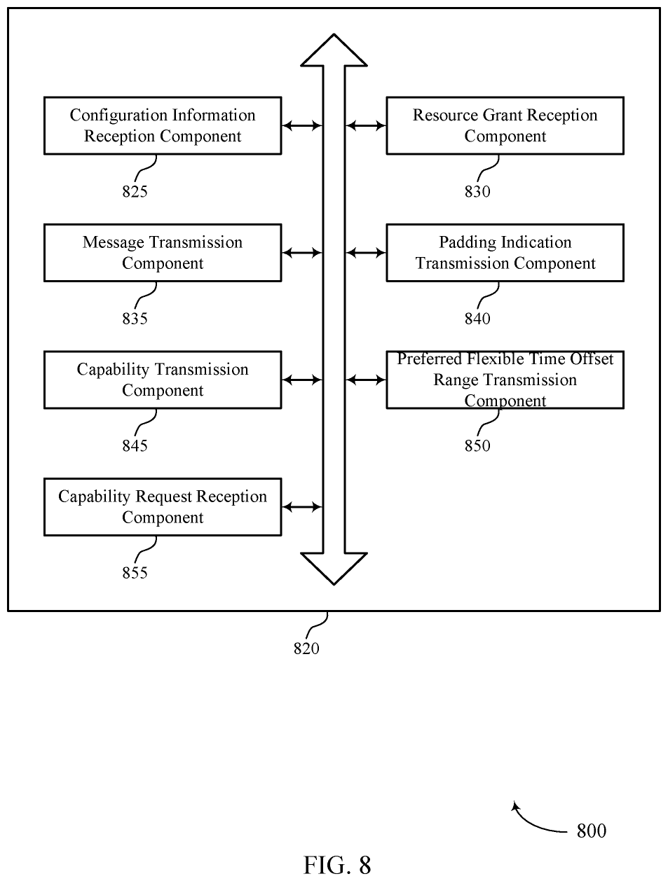

FIG. 8 shows a block diagram 800 of a communications manager 820 that supports the uplink padding indication and flexible K2 range in accordance with one or more aspects of the present disclosure. The communications manager 820 may be an example of aspects of a communications manager 620, a communications manager 720, or both, as described herein. The communications manager 820, or various components thereof, may be an example of means for performing various aspects of uplink padding indication and flexible K2 range as described herein. For example, the communications manager 820 may include a configuration information reception component 825, a resource grant reception component 830, a message transmission component 835, a padding indication transmission component 840, a capability transmission component 845, a preferred flexible time offset range transmission component 850, a capability request reception component 855, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The configuration information reception component 825 is capable of, configured to, or operable to support a means for receiving configuration information that enables the UE to report a padding indication that pertains to one or more padding bits the UE inserts and sends in one or more uplink transmissions. The resource grant reception component 830 is capable of, configured to, or operable to support a means for receiving a grant that indicates a set of resources for transmission of an uplink message by the UE. The message transmission component 835 is capable of, configured to, or operable to support a means for transmitting the uplink message. The padding indication transmission component 840 is capable of, configured to, or operable to support a means for transmitting the padding indication in accordance with the configuration information and based on a quantity of padding included by the UE in the uplink message.

In some examples, the capability transmission component 845 is capable of, configured to, or operable to support a means for transmitting a padding indication capability indicating that the UE is capable of reporting the padding indication.

In some examples, the capability request reception component 855 is capable of, configured to, or operable to support a means for receiving a padding indication capability request, where the transmission of the padding indication capability is based on receiving the padding indication capability request.

In some examples, to support transmitting the padding indication, the padding indication transmission component 840 is capable of, configured to, or operable to support a means for transmitting an indicator of a percentage of the uplink message or of a payload of the uplink message occupied by the padding.

In some examples, to support transmitting the padding indication, the padding indication transmission component 840 is capable of, configured to, or operable to support a means for transmitting an indicator of a percentage range of the uplink message or of a payload of the uplink message occupied by the padding.

In some examples, to support transmitting the padding indication, the padding indication transmission component 840 is capable of, configured to, or operable to support a means for transmitting an indicator that the quantity of padding included in the uplink message satisfies a threshold. In some examples, satisfaction of the threshold includes an amount of data for the transmission of the uplink message that is less than a UE buffer threshold.

In some examples, satisfaction of the threshold includes an amount of data for the transmission of the uplink message that is more than a UE buffer threshold. In some examples, the resource grant reception component 830 is capable of, configured to, or operable to support a means for receiving one or more future uplink grants, where the one or more future uplink grants are adjusted based on the padding indication.

Additionally, or alternatively, the communications manager 820 may support wireless communications in accordance with examples as disclosed herein. In some examples, the configuration information reception component 825 is capable of, configured to, or operable to support a means for receiving configuration information that enables the UE to apply a flexible time offset between receipt of an uplink grant and transmission of an uplink message associated with the uplink grant. In some examples, the resource grant reception component 830 is capable of, configured to, or operable to support a means for receiving the uplink grant that indicates resources for transmission of the uplink message, where the uplink grant also indicates a time offset range that defines valid time durations for the flexible time offset. In some examples, the message transmission component 835 is capable of, configured to, or operable to support a means for transmitting the uplink message in accordance with the flexible time offset that is within the time offset range.

In some examples, the capability transmission component 845 is capable of, configured to, or operable to support a means for transmitting a flexible time offset capability indicating that the UE is capable of applying the flexible time offset.

In some examples, the capability request reception component 855 is capable of, configured to, or operable to support a means for receiving a flexible time offset capability request, where the transmission of the flexible time offset capability is based on receiving the flexible time offset capability request.

In some examples, the resource grant reception component 830 is capable of, configured to, or operable to support a means for receiving an additional uplink grant scheduling one or more unused uplink slots of the time offset range. In some examples, the message transmission component 835 is capable of, configured to, or operable to support a means for transmitting an additional uplink message in accordance with the additional uplink grant in the one or more unused uplink slots.

In some examples, the preferred flexible time offset range transmission component 850 is capable of, configured to, or operable to support a means for transmitting an indication of a preferred flexible time offset range.

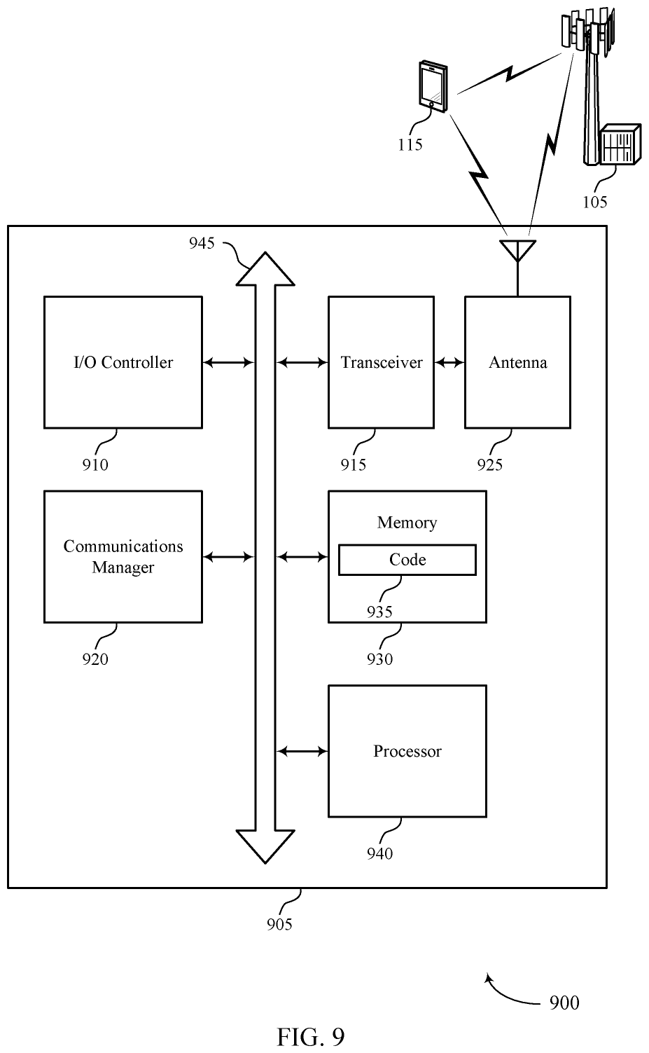

FIG. 9 shows a diagram of a system 900 including a device 905 that supports the uplink padding indication and flexible K2 range in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable code 935 including instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may contain, among other things, a basic I/O system (BIOS) which may control basic hardware or software operation such as the interaction with peripheral components or devices.

The at least one processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting uplink padding indication and flexible K2 range). For example, the device 905 or a component of the device 905 may include at least one processor 940 and at least one memory 930 coupled with or to the at least one processor 940, the at least one processor 940 and at least one memory 930 configured to perform various functions described herein. In some examples, the at least one processor 940 may include multiple processors and the at least one memory 930 may include multiple memories. One or more of the multiple processors may be coupled with one or more of the multiple memories, which may, individually or collectively, be configured to perform various functions herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving configuration information that enables the UE to report a padding indication that pertains to one or more padding bits the UE inserts and sends in one or more uplink transmissions. The communications manager 920 is capable of, configured to, or operable to support a means for receiving a grant that indicates a set of resources for transmission of an uplink message by the UE. The communications manager 920 is capable of, configured to, or operable to support a means for transmitting the uplink message. The communications manager 920 is capable of, configured to, or operable to support a means for transmitting the padding indication in accordance with the configuration information and based on a quantity of padding included by the UE in the uplink message.

Additionally, or alternatively, the communications manager 920 may support wireless communications in accordance with examples as disclosed herein. For example, the communications manager 920 is capable of, configured to, or operable to support a means for receiving configuration information that enables the UE to apply a flexible time offset between receipt of an uplink grant and transmission of an uplink message associated with the uplink grant. The communications manager 920 is capable of, configured to, or operable to support a means for receiving the uplink grant that indicates resources for transmission of the uplink message, where the uplink grant also indicates a time offset range that defines valid time durations for the flexible time offset. The communications manager 920 is capable of, configured to, or operable to support a means for transmitting the uplink message in accordance with the flexible time offset that is within the time offset range.

By including or configuring the communications manager 920 in accordance with examples as described herein, the device 905 may support techniques for the uplink padding and flexible K2 range, which may result in various advantages, including, improved communication reliability, reduced latency, improved user experience related to reduced processing, reduced power consumption, more efficient utilization of communication resources, improved coordination between devices, longer battery life, improved utilization of processing capability, among other advantages.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of uplink padding indication and flexible K2 range as described herein, or the at least one processor 940 and the at least one memory 930 may be otherwise configured to, individually or collectively, perform or support such operations.

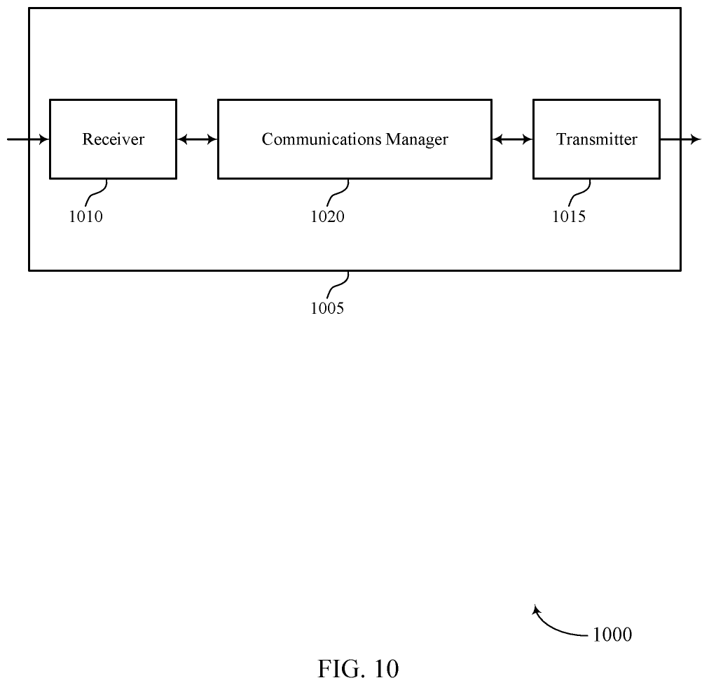

FIG. 10 shows a block diagram 1000 of a device 1005 that supports the uplink padding indication and flexible K2 range in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of uplink padding indication and flexible K2 range as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor. If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for transmitting configuration information that enables a UE to report a padding indication that pertains to one or more padding bits included by the UE in one or more uplink transmissions. The communications manager 1020 is capable of, configured to, or operable to support a means for transmitting a grant that indicates a set of resources for transmission of an uplink message by the UE. The communications manager 1020 is capable of, configured to, or operable to support a means for receiving the uplink message. The communications manager 1020 is capable of, configured to, or operable to support a means for receiving the padding indication in accordance with the configuration information and based on a quantity of padding included by the UE in the uplink message.

Additionally, or alternatively, the communications manager 1020 may support wireless communications in accordance with examples as disclosed herein. For example, the communications manager 1020 is capable of, configured to, or operable to support a means for transmitting configuration information that enables a UE to apply a flexible time offset between receipt of an uplink grant and transmission of an uplink message associated with the uplink grant. The communications manager 1020 is capable of, configured to, or operable to support a means for transmitting the uplink grant that indicates resources for transmission of the uplink message, where the uplink grant also indicates a time offset range that defines valid time durations for the flexible time offset. The communications manager 1020 is capable of, configured to, or operable to support a means for receiving the uplink message in accordance with the flexible time offset that is within the time offset range.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for the uplink padding and flexible K2 range, which may result in various advantages, including reduced processing, reduced power consumption, more efficient utilization of communication resources, among other advantages.

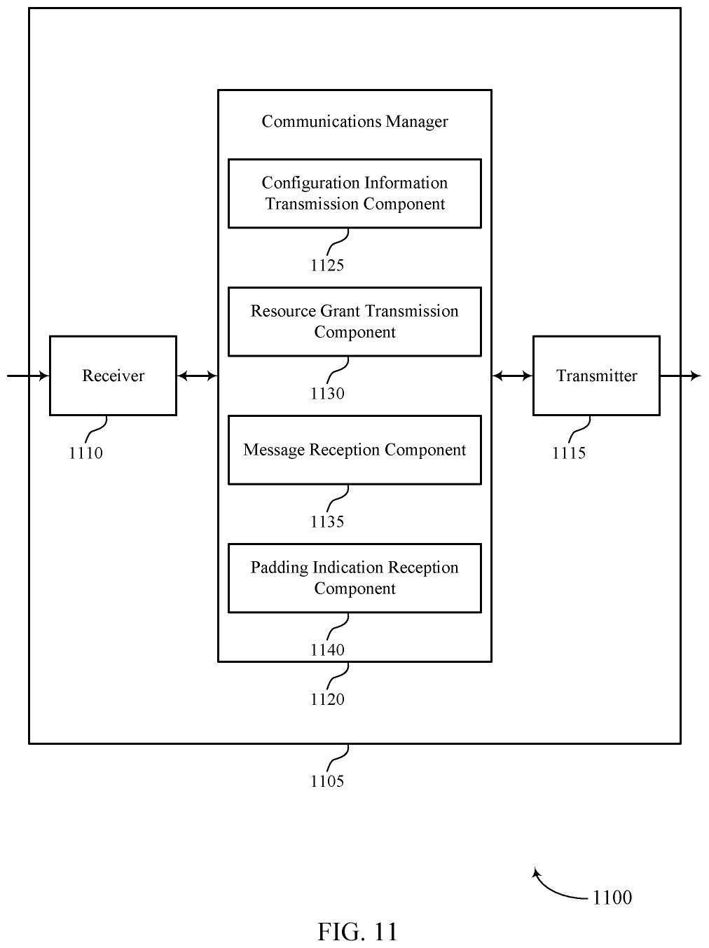

FIG. 11 shows a block diagram 1100 of a device 1105 that supports the uplink padding indication and flexible K2 range in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one of more components of the device 1105 (e.g., the receiver 1110, the transmitter 1115, and the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of uplink padding indication and flexible K2 range as described herein. For example, the communications manager 1120 may include a configuration information transmission component 1125, a resource grant transmission component 1130, a message reception component 1135, a padding indication reception component 1140, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The configuration information transmission component 1125 is capable of, configured to, or operable to support a means for transmitting configuration information that enables a UE to report a padding indication that pertains to one or more padding bits included by the UE in one or more uplink transmissions. The resource grant transmission component 1130 is capable of, configured to, or operable to support a means for transmitting a grant that indicates a set of resources for transmission of an uplink message by the UE. The message reception component 1135 is capable of, configured to, or operable to support a means for receiving the uplink message. The padding indication reception component 1140 is capable of, configured to, or operable to support a means for receiving the padding indication in accordance with the configuration information and based on a quantity of padding included by the UE in the uplink message.

Additionally, or alternatively, the communications manager 1120 may support wireless communications in accordance with examples as disclosed herein. The configuration information transmission component 1125 is capable of, configured to, or operable to support a means for transmitting configuration information that enables a UE to apply a flexible time offset between receipt of an uplink grant and transmission of an uplink message associated with the uplink grant. The resource grant transmission component 1130 is capable of, configured to, or operable to support a means for transmitting the uplink grant that indicates resources for transmission of the uplink message, where the uplink grant also indicates a time offset range that defines valid time durations for the flexible time offset. The message reception component 1135 is capable of, configured to, or operable to support a means for receiving the uplink message in accordance with the flexible time offset that is within the time offset range.

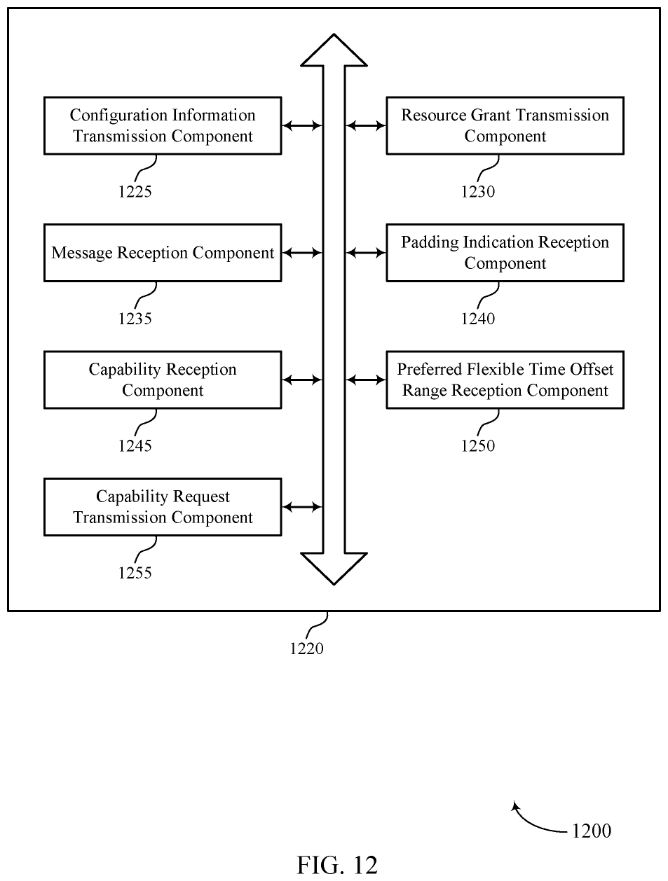

FIG. 12 shows a block diagram 1200 of a communications manager 1220 that supports the uplink padding indication and flexible K2 range in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of uplink padding indication and flexible K2 range as described herein. For example, the communications manager 1220 may include a configuration information transmission component 1225, a resource grant transmission component 1230, a message reception component 1235, a padding indication reception component 1240, a capability reception component 1245, a preferred flexible time offset range reception component 1250, a capability request transmission component 1255, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The configuration information transmission component 1225 is capable of, configured to, or operable to support a means for transmitting configuration information that enables a UE to report a padding indication that pertains to one or more padding bits included by the UE in one or more uplink transmissions. The resource grant transmission component 1230 is capable of, configured to, or operable to support a means for transmitting a grant that indicates a set of resources for transmission of an uplink message by the UE. The message reception component 1235 is capable of, configured to, or operable to support a means for receiving the uplink message. The padding indication reception component 1240 is capable of, configured to, or operable to support a means for receiving the padding indication in accordance with the configuration information and based on a quantity of padding included by the UE in the uplink message.

In some examples, the capability reception component 1245 is capable of, configured to, or operable to support a means for receiving a padding indication capability indicating that the UE is capable of reporting the padding indication.

In some examples, the capability request transmission component 1255 is capable of, configured to, or operable to support a means for transmitting a padding indication capability request, where reception of the padding indication capability is based on transmitting the padding indication capability request.

In some examples, to support receiving the padding indication, the padding indication reception component 1240 is capable of, configured to, or operable to support a means for receiving an indicator of a percentage of the uplink message or of a payload of the uplink message occupied by the padding.

In some examples, to support receiving the padding indication, the padding indication reception component 1240 is capable of, configured to, or operable to support a means for receiving an indicator of a percentage range of the uplink message or of a payload of the uplink message occupied by the padding.

In some examples, to support receiving the padding indication, the padding indication reception component 1240 is capable of, configured to, or operable to support a means for receiving an indicator that the quantity of padding included in the uplink message satisfies a threshold.

In some examples, satisfaction of the threshold includes the UE having an amount of data that is less than a UE buffer threshold. In some examples, satisfaction of the threshold includes the UE having an amount of data that is more than a UE buffer threshold. In some examples, the resource grant transmission component 1230 is capable of, configured to, or operable to support a means for adjusting one or more future uplink grants based on the padding indication of the user equipment.

In some examples, adjusting the one or more future uplink grants includes adjusting transport block size via a modulation and coding scheme, physical resource block size, physical resource block allocation, allocation of layers, skipping of a scheduled uplink grant, or a combination thereof.

Additionally, or alternatively, the communications manager 1220 may support wireless communications in accordance with examples as disclosed herein. In some examples, the configuration information transmission component 1225 is capable of, configured to, or operable to support a means for transmitting configuration information that enables a UE to apply a flexible time offset between receipt of an uplink grant and transmission of an uplink message associated with the uplink grant. In some examples, the resource grant transmission component 1230 is capable of, configured to, or operable to support a means for transmitting the uplink grant that indicates resources for transmission of the uplink message, where the uplink grant also indicates a time offset range that defines valid time durations for the flexible time offset. In some examples, the message reception component 1235 is capable of, configured to, or operable to support a means for receiving the uplink message in accordance with the flexible time offset that is within the time offset range.

In some examples, the capability reception component 1245 is capable of, configured to, or operable to support a means for receiving a flexible time offset capability indicating that the UE is capable of applying the flexible time offset.

In some examples, the capability request transmission component 1255 is capable of, configured to, or operable to support a means for transmitting a flexible time offset capability request, where the transmission of the flexible time offset capability is based on receiving the flexible time offset capability request. In some examples, the preferred flexible time offset range reception component 1250 is capable of, configured to, or operable to support a means for receiving an indication of a preferred flexible time offset range.

In some examples, the resource grant transmission component 1230 is capable of, configured to, or operable to support a means for transmitting an additional uplink grant scheduling one or more unused uplink slots of the time offset range. In some examples, the message reception component 1235 is capable of, configured to, or operable to support a means for receiving an additional uplink message in accordance with the additional uplink grant in the one or more unused uplink slots.

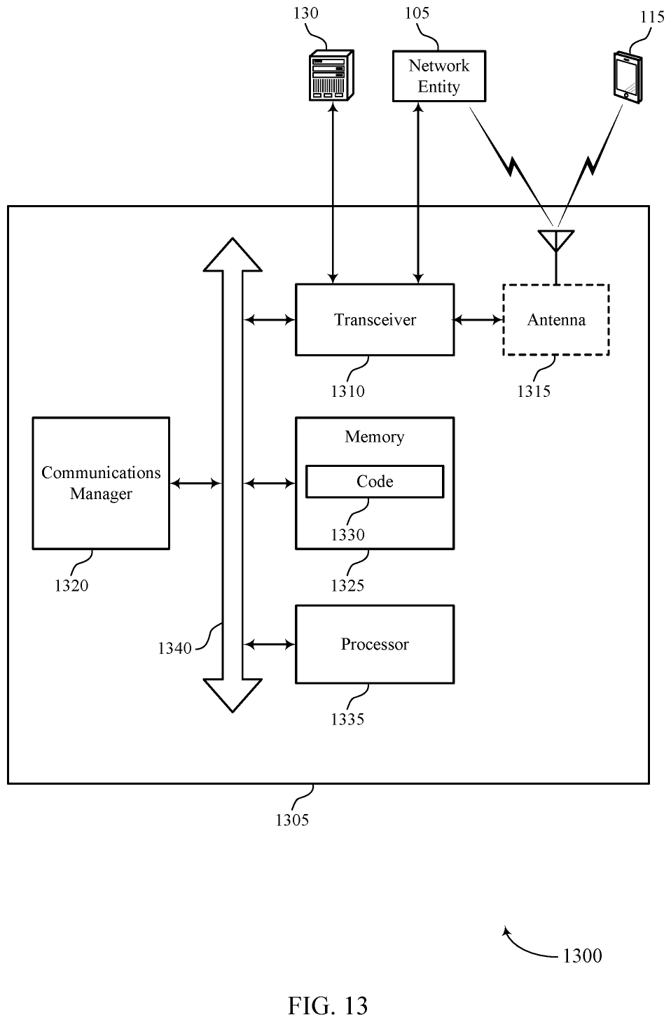

FIG. 13 shows a diagram of a system 1300 including a device 1305 that supports the uplink padding indication and flexible K2 range in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., a communication link 125, a backhaul communication link 120, a midhaul communication link 162, a fronthaul communication link 168).

The at least one memory 1325 may include RAM, ROM, or any combination thereof. The at least one memory 1325 may store computer-readable, computer-executable code 1330 including instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may contain, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting uplink padding indication and flexible K2 range). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325). In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for transmitting configuration information that enables a UE to report a padding indication that pertains to one or more padding bits included by the UE in one or more uplink transmissions. The communications manager 1320 is capable of, configured to, or operable to support a means for transmitting a grant that indicates a set of resources for transmission of an uplink message by the UE. The communications manager 1320 is capable of, configured to, or operable to support a means for receiving the uplink message. The communications manager 1320 is capable of, configured to, or operable to support a means for receiving the padding indication in accordance with the configuration information and based on a quantity of padding included by the UE in the uplink message.

Additionally, or alternatively, the communications manager 1320 may support wireless communications in accordance with examples as disclosed herein. For example, the communications manager 1320 is capable of, configured to, or operable to support a means for transmitting configuration information that enables a UE to apply a flexible time offset between receipt of an uplink grant and transmission of an uplink message associated with the uplink grant. The communications manager 1320 is capable of, configured to, or operable to support a means for transmitting the uplink grant that indicates resources for transmission of the uplink message, where the uplink grant also indicates a time offset range that defines valid time durations for the flexible time offset. The communications manager 1320 is capable of, configured to, or operable to support a means for receiving the uplink message in accordance with the flexible time offset that is within the time offset range.

By including or configuring the communications manager 1320 in accordance with examples as described herein, the device 1305 may support techniques for the uplink padding and flexible K2 range, which may result in various advantages, including improved communication reliability, reduced latency, improved user experience related to reduced processing, reduced power consumption, more efficient utilization of communication resources, improved coordination between devices, longer battery life, improved utilization of processing capability, among other advantages.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of uplink padding indication and flexible K2 range as described herein, or the at least one processor 1335 and the at least one memory 1325 may be otherwise configured to, individually or collectively, perform or support such operations.

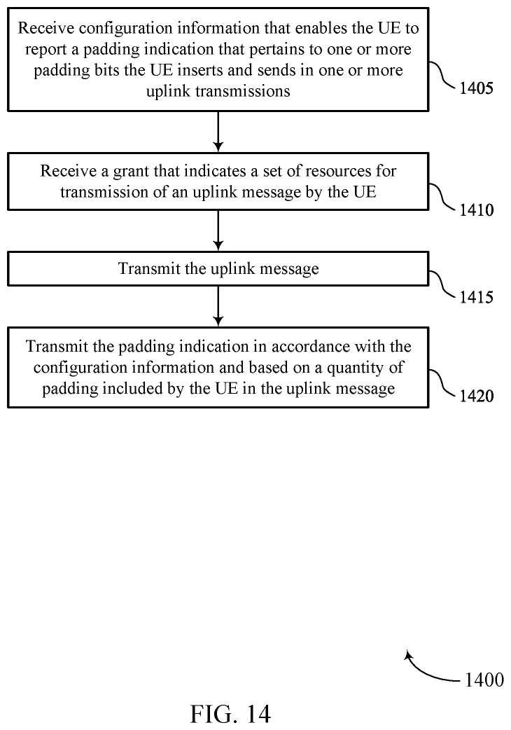

FIG. 14 shows a flowchart illustrating a method 1400 that supports the uplink padding indication and flexible K2 range in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving configuration information that enables the UE to report a padding indication that pertains to one or more padding bits the UE inserts and sends in one or more uplink transmissions. The operations of block 1405 may be performed in accordance with examples as disclosed herein. In some examples, aspects of the operations of 1405 may be performed by a configuration information reception component 825 as described with reference to FIG. 8.

At 1410, the method may include receiving a grant that indicates a set of resources for transmission of an uplink message by the UE. The operations of block 1410 may be performed in accordance with examples as disclosed herein. In some examples, aspects of the operations of 1410 may be performed by a resource grant reception component 830 as described with reference to FIG. 8.

At 1415, the method may include transmitting the uplink message. The operations of block 1415 may be performed in accordance with examples as disclosed herein. In some examples, aspects of the operations of 1415 may be performed by a message transmission component 835 as described with reference to FIG. 8.

At 1420, the method may include transmitting the padding indication in accordance with the configuration information and based on a quantity of padding included by the UE in the uplink message. The operations of block 1420 may be performed in accordance with examples as disclosed herein. In some examples, aspects of the operations of 1420 may be performed by a padding indication transmission component 840 as described with reference to FIG. 8.

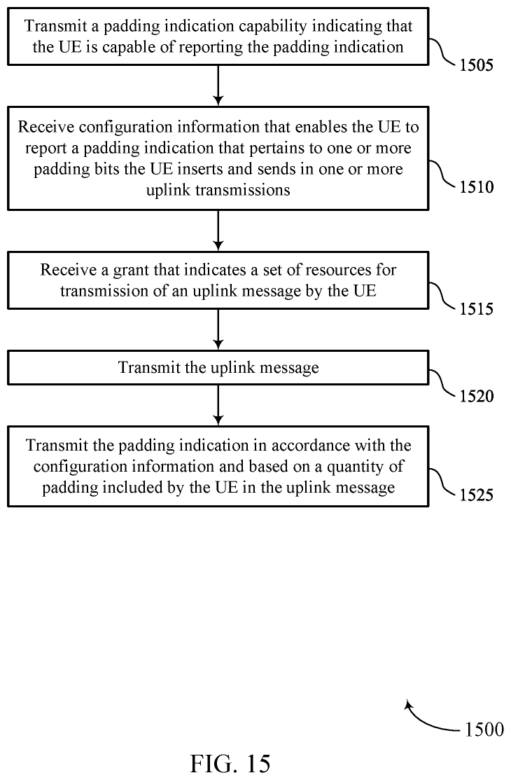

FIG. 15 shows a flowchart illustrating a method 1500 that supports uplink padding indication and flexible K2 range in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include transmitting a padding indication capability indicating that the UE is capable of reporting the padding indication. The operations of block 1505 may be performed in accordance with examples as disclosed herein. In some examples, aspects of the operations of 1505 may be performed by a capability transmission component 845 as described with reference to FIG. 8.

At 1510, the method may include receiving configuration information that enables the UE to report a padding indication that pertains to one or more padding bits the UE inserts and sends in one or more uplink transmissions. The operations of block 1510 may be performed in accordance with examples as disclosed herein. In some examples, aspects of the operations of 1510 may be performed by a configuration information reception component 825 as described with reference to FIG. 8.

At 1515, the method may include receiving a grant that indicates a set of resources for transmission of an uplink message by the UE. The operations of block 1515 may be performed in accordance with examples as disclosed herein. In some examples, aspects of the operations of 1515 may be performed by a resource grant reception component 830 as described with reference to FIG. 8.

At 1520, the method may include transmitting the uplink message. The operations of block 1520 may be performed in accordance with examples as disclosed herein. In some examples, aspects of the operations of 1520 may be performed by a message transmission component 835 as described with reference to FIG. 8.

At 1525, the method may include transmitting the padding indication in accordance with the configuration information and based on a quantity of padding included by the UE in the uplink message. The operations of block 1525 may be performed in accordance with examples as disclosed herein. In some examples, aspects of the operations of 1525 may be performed by a padding indication transmission component 840 as described with reference to FIG. 8.

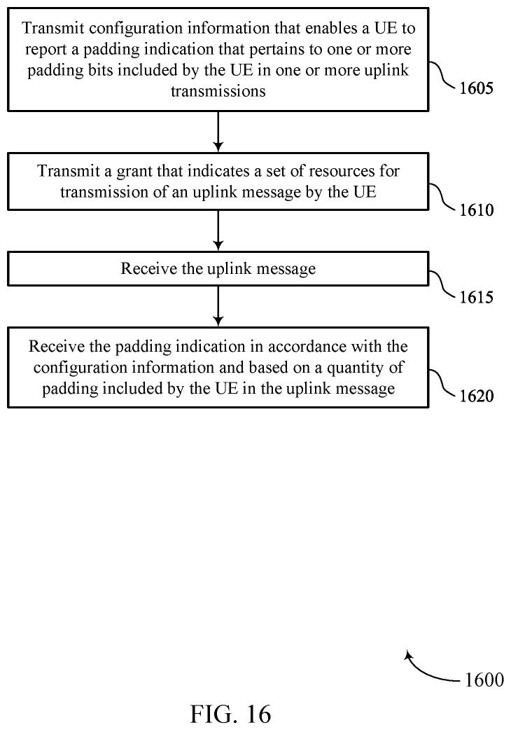

FIG. 16 shows a flowchart illustrating a method 1600 that supports the uplink padding indication and flexible K2 range in accordance with one or more aspects of the present disclosure. The operations of the method 1600 may be implemented by a network entity or its components as described herein. For example, the operations of the method 1600 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1605, the method may include transmitting configuration information that enables a UE to report a padding indication that pertains to one or more padding bits included by the UE in one or more uplink transmissions. The operations of block 1605 may be performed in accordance with examples as disclosed herein. In some examples, aspects of the operations of 1605 may be performed by a configuration information transmission component 1225 as described with reference to FIG. 12.

At 1610, the method may include transmitting a grant that indicates a set of resources for transmission of an uplink message by the UE. The operations of block 1610 may be performed in accordance with examples as disclosed herein. In some examples, aspects of the operations of 1610 may be performed by a resource grant transmission component 1230 as described with reference to FIG. 12.

At 1615, the method may include receiving the uplink message. The operations of block 1615 may be performed in accordance with examples as disclosed herein. In some examples, aspects of the operations of 1615 may be performed by a message reception component 1235 as described with reference to FIG. 12.

At 1620, the method may include receiving the padding indication in accordance with the configuration information and based on a quantity of padding included by the UE in the uplink message. The operations of block 1620 may be performed in accordance with examples as disclosed herein. In some examples, aspects of the operations of 1620 may be performed by a padding indication reception component 1240 as described with reference to FIG. 12.

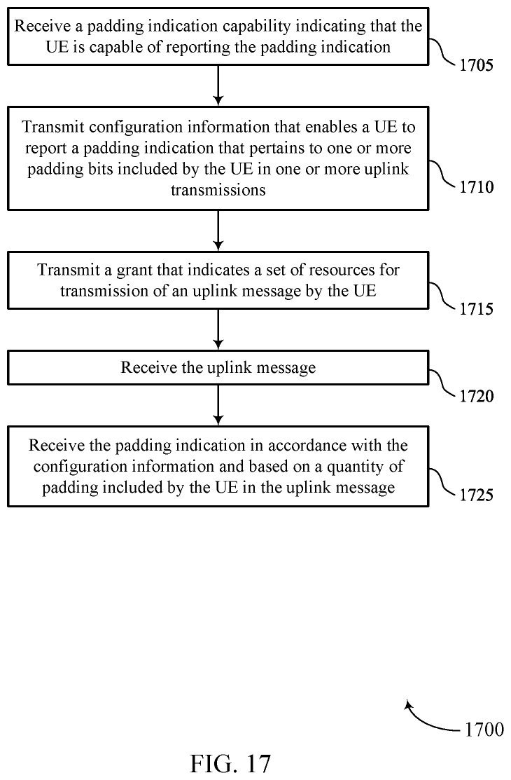

FIG. 17 shows a flowchart illustrating a method 1700 that supports the uplink padding indication and flexible K2 range in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include receiving a padding indication capability indicating that the UE is capable of reporting the padding indication. The operations of block 1705 may be performed in accordance with examples as disclosed herein. In some examples, aspects of the operations of 1705 may be performed by a capability reception component 1245 as described with reference to FIG. 12.

At 1710, the method may include transmitting configuration information that enables a UE to report a padding indication that pertains to one or more padding bits included by the UE in one or more uplink transmissions. The operations of block 1710 may be performed in accordance with examples as disclosed herein. In some examples, aspects of the operations of 1710 may be performed by a configuration information transmission component 1225 as described with reference to FIG. 12.

At 1715, the method may include transmitting a grant that indicates a set of resources for transmission of an uplink message by the UE. The operations of block 1715 may be performed in accordance with examples as disclosed herein. In some examples, aspects of the operations of 1715 may be performed by a resource grant transmission component 1230 as described with reference to FIG. 12.

At 1720, the method may include receiving the uplink message. The operations of block 1720 may be performed in accordance with examples as disclosed herein. In some examples, aspects of the operations of 1720 may be performed by a message reception component 1235 as described with reference to FIG. 12.

At 1725, the method may include receiving the padding indication in accordance with the configuration information and based on a quantity of padding included by the UE in the uplink message. The operations of block 1725 may be performed in accordance with examples as disclosed herein. In some examples, aspects of the operations of 1725 may be performed by a padding indication reception component 1240 as described with reference to FIG. 12.

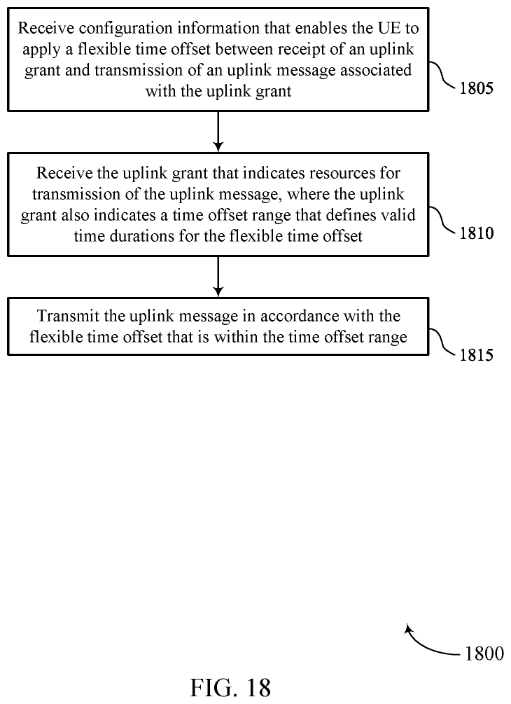

FIG. 18 shows a flowchart illustrating a method 1800 that supports the uplink padding indication and flexible K2 range in accordance with one or more aspects of the present disclosure. The operations of the method 1800 may be implemented by a UE or its components as described herein. For example, the operations of the method 1800 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1805, the method may include receiving configuration information that enables the UE to apply a flexible time offset between receipt of an uplink grant and transmission of an uplink message associated with the uplink grant. The operations of block 1805 may be performed in accordance with examples as disclosed herein. In some examples, aspects of the operations of 1805 may be performed by a configuration information reception component 825 as described with reference to FIG. 8.

At 1810, the method may include receiving the uplink grant that indicates resources for transmission of the uplink message, where the uplink grant also indicates a time offset range that defines valid time durations for the flexible time offset. The operations of block 1810 may be performed in accordance with examples as disclosed herein. In some examples, aspects of the operations of 1810 may be performed by a resource grant reception component 830 as described with reference to FIG. 8.

At 1815, the method may include transmitting the uplink message in accordance with the flexible time offset that is within the time offset range. The operations of block 1815 may be performed in accordance with examples as disclosed herein. In some examples, aspects of the operations of 1815 may be performed by a message transmission component 835 as described with reference to FIG. 8.

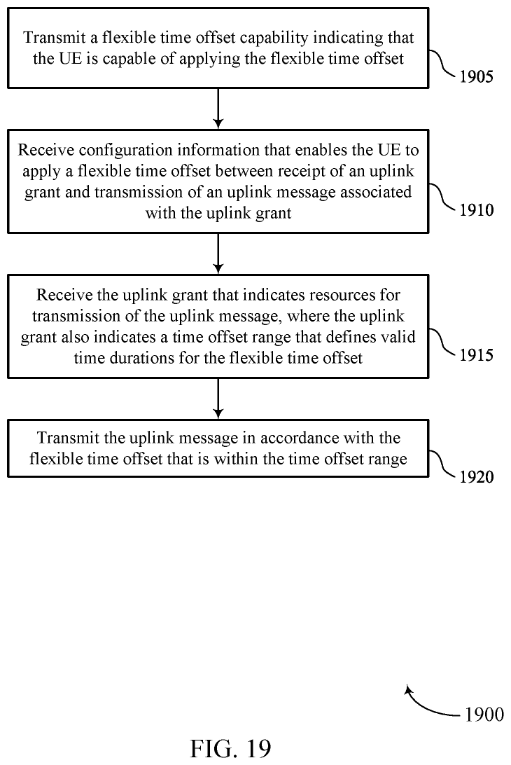

FIG. 19 shows a flowchart illustrating a method 1900 that supports the uplink padding indication and flexible K2 range in accordance with one or more aspects of the present disclosure. The operations of the method 1900 may be implemented by a UE or its components as described herein. For example, the operations of the method 1900 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1905, the method may include transmitting a flexible time offset capability indicating that the UE is capable of applying the flexible time offset. The operations of block 1905 may be performed in accordance with examples as disclosed herein. In some examples, aspects of the operations of 1905 may be performed by a capability transmission component 845 as described with reference to FIG. 8.

At 1910, the method may include receiving configuration information that enables the UE to apply a flexible time offset between receipt of an uplink grant and transmission of an uplink message associated with the uplink grant. The operations of block 1910 may be performed in accordance with examples as disclosed herein. In some examples, aspects of the operations of 1910 may be performed by a configuration information reception component 825 as described with reference to FIG. 8.

At 1915, the method may include receiving the uplink grant that indicates resources for transmission of the uplink message, where the uplink grant also indicates a time offset range that defines valid time durations for the flexible time offset. The operations of block 1915 may be performed in accordance with examples as disclosed herein. In some examples, aspects of the operations of 1915 may be performed by a resource grant reception component 830 as described with reference to FIG. 8.

At 1920, the method may include transmitting the uplink message in accordance with the flexible time offset that is within the time offset range. The operations of block 1920 may be performed in accordance with examples as disclosed herein. In some examples, aspects of the operations of 1920 may be performed by a message transmission component 835 as described with reference to FIG. 8.

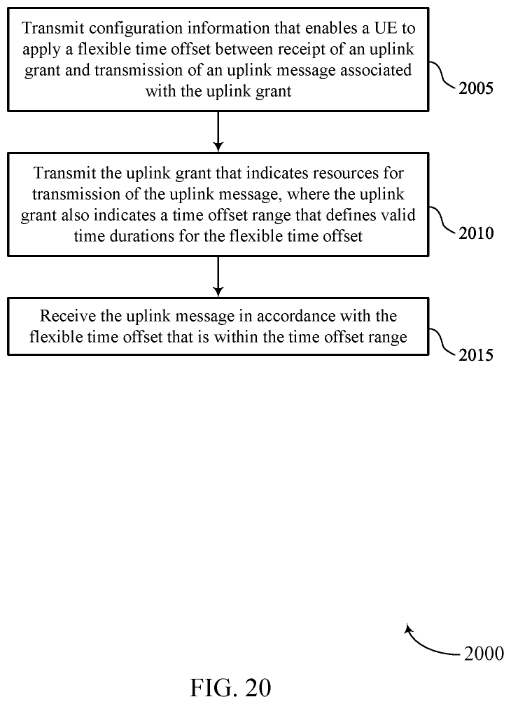

FIG. 20 shows a flowchart illustrating a method 2000 that supports the uplink padding indication and flexible K2 range in accordance with one or more aspects of the present disclosure. The operations of the method 2000 may be implemented by a network entity or its components as described herein. For example, the operations of the method 2000 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 2005, the method may include transmitting configuration information that enables a UE to apply a flexible time offset between receipt of an uplink grant and transmission of an uplink message associated with the uplink grant. The operations of block 2005 may be performed in accordance with examples as disclosed herein. In some examples, aspects of the operations of 2005 may be performed by a configuration information transmission component 1225 as described with reference to FIG. 12.

At 2010, the method may include transmitting the uplink grant that indicates resources for transmission of the uplink message, where the uplink grant also indicates a time offset range that defines valid time durations for the flexible time offset. The operations of block 2010 may be performed in accordance with examples as disclosed herein. In some examples, aspects of the operations of 2010 may be performed by a resource grant transmission component 1230 as described with reference to FIG. 12.

At 2015, the method may include receiving the uplink message in accordance with the flexible time offset that is within the time offset range. The operations of block 2015 may be performed in accordance with examples as disclosed herein. In some examples, aspects of the operations of 2015 may be performed by a message reception component 1235 as described with reference to FIG. 12.

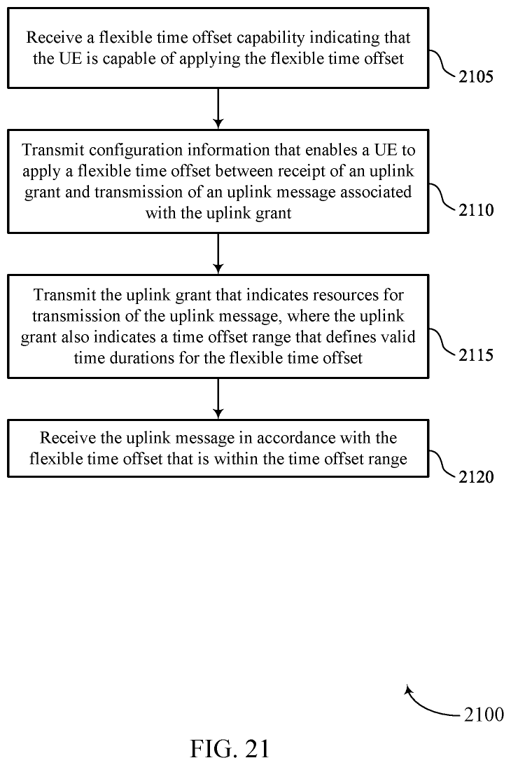

FIG. 21 shows a flowchart illustrating a method 2100 that supports the uplink padding indication and flexible K2 range in accordance with one or more aspects of the present disclosure. The operations of the method 2100 may be implemented by a network entity or its components as described herein. For example, the operations of the method 2100 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 2105, the method may include receiving a flexible time offset capability indicating that the UE is capable of applying the flexible time offset. The operations of block 2105 may be performed in accordance with examples as disclosed herein. In some examples, aspects of the operations of 2105 may be performed by a capability reception component 1245 as described with reference to FIG. 12.

At 2110, the method may include transmitting configuration information that enables a UE to apply a flexible time offset between receipt of an uplink grant and transmission of an uplink message associated with the uplink grant. The operations of block 2110 may be performed in accordance with examples as disclosed herein. In some examples, aspects of the operations of 2110 may be performed by a configuration information transmission component 1225 as described with reference to FIG. 12.

At 2115, the method may include transmitting the uplink grant that indicates resources for transmission of the uplink message, where the uplink grant also indicates a time offset range that defines valid time durations for the flexible time offset. The operations of block 2115 may be performed in accordance with examples as disclosed herein. In some examples, aspects of the operations of 2115 may be performed by a resource grant transmission component 1230 as described with reference to FIG. 12.

At 2120, the method may include receiving the uplink message in accordance with the flexible time offset that is within the time offset range. The operations of block 2120 may be performed in accordance with examples as disclosed herein. In some examples, aspects of the operations of 2120 may be performed by a message reception component 1235 as described with reference to FIG. 12.

The following provides an overview of aspects of the present disclosure:

Aspect 1: A method for wireless communications at a UE, comprising: receiving configuration information that enables the UE to report a padding indication that pertains to one or more padding bits the UE inserts and sends in one or more uplink transmissions; receiving a grant that indicates a set of resources for transmission of an uplink message by the UE; transmitting the uplink message; and transmitting the padding indication in accordance with the configuration information and based on a quantity of padding included by the UE in the uplink message.

Aspect 2: The method of aspect 1, further comprising: transmitting a padding indication capability indicating that the UE is capable of reporting the padding indication.

Aspect 3: The method of aspect 2, further comprising: receiving a padding indication capability request, wherein the transmission of the padding indication capability is based at least in part on receiving the padding indication capability request.

Aspect 4: The method of any of aspects 1 through 3, wherein transmitting the padding indication comprises: transmitting an indicator of a percentage of the uplink message or of a payload of the uplink message occupied by the padding.

Aspect 5: The method of any of aspects 1 through 4, wherein transmitting the padding indication comprises: transmitting an indicator of a percentage range of the uplink message or of a payload of the uplink message occupied by the padding.

Aspect 6: The method of any of aspects 1 through 5, wherein transmitting the padding indication comprises: transmitting an indicator that the quantity of padding included in the uplink message satisfies a threshold.

Aspect 7: The method of aspect 6, wherein satisfaction of the threshold comprises an amount of data for the transmission of the uplink message that is less than a UE buffer threshold.

Aspect 8: The method of any of aspects 6 through 7, wherein satisfaction of the threshold comprises an amount of data for the transmission of the uplink message that is more than a UE buffer threshold.

Aspect 9: The method of any of aspects 1 through 8, further comprising: receiving one or more future uplink grants, wherein the one or more future uplink grants are adjusted based at least in part on the padding indication.

Aspect 10: A method for wireless communications at a network entity, comprising: transmitting configuration information that enables a UE to report a padding indication that pertains to one or more padding bits included by the UE in one or more uplink transmissions; transmitting a grant that indicates a set of resources for transmission of an uplink message by the UE; receiving the uplink message; and receiving the padding indication in accordance with the configuration information and based on a quantity of padding included by the UE in the uplink message.

Aspect 11: The method of aspect 10, further comprising: receiving a padding indication capability indicating that the UE is capable of reporting the padding indication.

Aspect 12: The method of aspect 11, further comprising: transmitting a padding indication capability request, wherein reception of the padding indication capability is based at least in part on transmitting the padding indication capability request.

Aspect 13: The method of any of aspects 10 through 12, wherein receiving the padding indication comprises: receiving an indicator of a percentage of the uplink message or of a payload of the uplink message occupied by the padding.

Aspect 14: The method of any of aspects 10 through 13, wherein receiving the padding indication comprises: receiving an indicator of a percentage range of the uplink message or of a payload of the uplink message occupied by the padding.

Aspect 15: The method of any of aspects 10 through 14, wherein receiving the padding indication comprises: receiving an indicator that the quantity of padding included in the uplink message satisfies a threshold.

Aspect 16: The method of aspect 15, wherein satisfaction of the threshold comprises the UE having an amount of data that is less than a UE buffer threshold.

Aspect 17: The method of any of aspects 15 through 16, wherein satisfaction of the threshold comprises the UE having an amount of data that is more than a UE buffer threshold.

Aspect 18: The method of any of aspects 10 through 17, further comprising: adjusting one or more future uplink grants based at least in part on the padding indication of the user equipment.

Aspect 19: The method of aspect 18, wherein adjusting the one or more future uplink grants comprises adjusting transport block size via a modulation and coding scheme, physical resource block size, physical resource block allocation, allocation of layers, skipping of a scheduled uplink grant, or a combination thereof.

Aspect 20: A method for wireless communications at a UE, comprising: receiving configuration information that enables the UE to apply a flexible time offset (e.g., flexible K2 range) between receipt of an uplink grant and transmission of an uplink message associated with the uplink grant; receiving the uplink grant that indicates resources for transmission of the uplink message, wherein the uplink grant also indicates a time offset range that defines valid time durations for the flexible time offset; and transmitting the uplink message in accordance with the flexible time offset that is within the time offset range.

Aspect 21: The method of aspect 20, further comprising: transmitting a flexible time offset capability indicating that the UE is capable of applying the flexible time offset.

Aspect 22: The method of aspect 21, further comprising: receiving a flexible time offset capability request, wherein the transmission of the flexible time offset capability is based at least in part on receiving the flexible time offset capability request.

Aspect 23: The method of any of aspects 20 through 22, further comprising: receiving an additional uplink grant scheduling one or more unused uplink slots of the time offset range; and transmitting an additional uplink message in accordance with the additional uplink grant in the one or more unused uplink slots.

Aspect 24: The method of any of aspects 20 through 23, further comprising: transmitting an indication of a preferred flexible time offset range.

Aspect 25: A method for wireless communications at a network entity, comprising: transmitting configuration information that enables a UE to apply a flexible time offset between receipt of an uplink grant and transmission of an uplink message associated with the uplink grant; transmitting the uplink grant that indicates resources for transmission of the uplink message, wherein the uplink grant also indicates a time offset range that defines valid time durations for the flexible time offset; and receiving the uplink message in accordance with the flexible time offset that is within the time offset range.

Aspect 26: The method of aspect 25, further comprising: receiving a flexible time offset capability indicating that the UE is capable of applying the flexible time offset.

Aspect 27: The method of aspect 26, further comprising: transmitting a flexible time offset capability request, wherein the transmission of the flexible time offset capability is based at least in part on receiving the flexible time offset capability request.

Aspect 28: The method of any of aspects 25 through 27, further comprising: receiving an indication of a preferred flexible time offset range.

Aspect 29: The method of any of aspects 25 through 28, further comprising: transmitting an additional uplink grant scheduling one or more unused uplink slots of the time offset range; and receiving an additional uplink message in accordance with the additional uplink grant in the one or more unused uplink slots.

Aspect 30: A UE for wireless communications, comprising one or more memories storing processor-executable code, and one or more processors coupled with the one or more memories and individually or collectively operable to execute the code to cause the UE to perform a method of any of aspects 1 through 9.

Aspect 31: A UE for wireless communications, comprising at least one means for performing a method of any of aspects 1 through 9.

Aspect 32: A non-transitory computer-readable medium storing code for wireless communications, the code comprising instructions executable by one or more processors to perform a method of any of aspects 1 through 9.

Aspect 33: A network entity for wireless communications, comprising one or more memories storing processor-executable code, and one or more processors coupled with the one or more memories and individually or collectively operable to execute the code to cause the network entity to perform a method of any of aspects 10 through 19.

Aspect 34: A network entity for wireless communications, comprising at least one means for performing a method of any of aspects 10 through 19.

Aspect 35: A non-transitory computer-readable medium storing code for wireless communications, the code comprising instructions executable by one or more processors to perform a method of any of aspects 10 through 19.

Aspect 36: A UE for wireless communications, comprising one or more memories storing processor-executable code, and one or more processors coupled with the one or more memories and individually or collectively operable to execute the code to cause the UE to perform a method of any of aspects 20 through 24.

Aspect 37: A UE for wireless communications, comprising at least one means for performing a method of any of aspects 20 through 24.

Aspect 38: A non-transitory computer-readable medium storing code for wireless communications, the code comprising instructions executable by one or more processors to perform a method of any of aspects 20 through 24.

Aspect 39: A network entity for wireless communications, comprising one or more memories storing processor-executable code, and one or more processors coupled with the one or more memories and individually or collectively operable to execute the code to cause the network entity to perform a method of any of aspects 25 through 29.

Aspect 40: A network entity for wireless communications, comprising at least one means for performing a method of any of aspects 25 through 29.

Aspect 41: A non-transitory computer-readable medium storing code for wireless communications, the code comprising instructions executable by one or more processors to perform a method of any of aspects 25 through 29.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive configuration information that enables the UE to report a padding indication that pertains to one or more padding bits the UE inserts and sends in one or more uplink transmissions;
receive a grant that indicates a set of resources for transmission of an uplink message by the UE;
transmit the uplink message; and
transmit the padding indication in accordance with the configuration information and based on a quantity of padding included by the UE in the uplink message.

2. The UE of claim 1, wherein the one or more processors are individually or collectively further operable to execute the code to cause the UE to:
transmit a padding indication capability indicating that the UE is capable of reporting the padding indication.

3. The UE of claim 2, wherein the one or more processors are individually or collectively further operable to execute the code to cause the UE to:
receive a padding indication capability request, wherein the transmission of the padding indication capability is based at least in part on receiving the padding indication capability request.

4. The UE of claim 1, wherein, to transmit the padding indication, the one or more processors are individually or collectively operable to execute the code to cause the UE to:
transmit an indicator of a percentage of the uplink message or of a payload of the uplink message occupied by the padding.

5. The UE of claim 1, wherein, to transmit the padding indication, the one or more processors are individually or collectively operable to execute the code to cause the UE to:
transmit an indicator of a percentage range of the uplink message or of a payload of the uplink message occupied by the padding.

6. The UE of claim 1, wherein, to transmit the padding indication, the one or more processors are individually or collectively operable to execute the code to cause the UE to:
transmit an indicator that the quantity of padding included in the uplink message satisfies a threshold.

7. The UE of claim 6, wherein satisfaction of the threshold comprises an amount of data for the transmission of the uplink message that is less than a UE buffer threshold.

8. The UE of claim 6, wherein satisfaction of the threshold comprises an amount of data for the transmission of the uplink message that is more than a UE buffer threshold.

9. The UE of claim 1, wherein the one or more processors are individually or collectively further operable to execute the code to cause the UE to:
receive one or more future uplink grants, wherein the one or more future uplink grants are adjusted based at least in part on the padding indication.

10. A network entity, comprising:
one or more memories storing processor-executable code; and
one or more processors coupled with the one or more memories and individually or collectively operable to execute the code to cause the network entity to:
transmit configuration information that enables a user equipment (UE) to report a padding indication that pertains to one or more padding bits included by the UE in one or more uplink transmissions;
transmit a grant that indicates a set of resources for transmission of an uplink message by the UE;
receive the uplink message; and
receive the padding indication in accordance with the configuration information and based on a quantity of padding included by the UE in the uplink message.

11. The network entity of claim 10, wherein the one or more processors are individually or collectively further operable to execute the code to cause the network entity to:
receive a padding indication capability indicating that the UE is capable of reporting the padding indication.

12. The network entity of claim 11, wherein the one or more processors are individually or collectively further operable to execute the code to cause the network entity to:
transmit a padding indication capability request, wherein reception of the padding indication capability is based at least in part on transmitting the padding indication capability request.

13. The network entity of claim 10, wherein, to receive the padding indication, the one or more processors are individually or collectively operable to execute the code to cause the network entity to:
receive an indicator of a percentage of the uplink message or of a payload of the uplink message occupied by the padding.

14. The network entity of claim 10, wherein, to receive the padding indication, the one or more processors are individually or collectively operable to execute the code to cause the network entity to:
receive an indicator of a percentage range of the uplink message or of a payload of the uplink message occupied by the padding.

15. The network entity of claim 10, wherein, to receive the padding indication, the one or more processors are individually or collectively operable to execute the code to cause the network entity to:
receive an indicator that the quantity of padding included in the uplink message satisfies a threshold.

16. The network entity of claim 15, wherein satisfaction of the threshold comprises the UE having an amount of data that is less than a UE buffer threshold.

17. The network entity of claim 15, wherein satisfaction of the threshold comprises the UE having an amount of data that is more than a UE buffer threshold.

18. The network entity of claim 10, wherein the one or more processors are individually or collectively further operable to execute the code to cause the network entity to:
adjust one or more future uplink grants based at least in part on the padding indication of the user equipment.

19. The network entity of claim 18, wherein adjusting the one or more future uplink grants comprises adjusting transport block size via a modulation and coding scheme, physical resource block size, physical resource block allocation, allocation of layers, skipping of a scheduled uplink grant, or a combination thereof.

20. A user equipment (UE), comprising:
one or more memories storing processor-executable code; and
one or more processors coupled with the one or more memories and individually or collectively operable to execute the code to cause the UE to:
receive configuration information that enables the UE to apply a flexible time offset between receipt of an uplink grant and transmission of an uplink message associated with the uplink grant;
receive the uplink grant that indicates resources for transmission of the uplink message, wherein the uplink grant also indicates a time offset range that defines valid time durations for the flexible time offset; and
transmit the uplink message in accordance with the flexible time offset that is within the time offset range.

21. The UE of claim 20, wherein the one or more processors are individually or collectively further operable to execute the code to cause the UE to:
transmit a flexible time offset capability indicating that the UE is capable of applying the flexible time offset.

22. The UE of claim 21, wherein the one or more processors are individually or collectively further operable to execute the code to cause the UE to:
receive a flexible time offset capability request, wherein the transmission of the flexible time offset capability is based at least in part on receiving the flexible time offset capability request.

23. The UE of claim 20, wherein the one or more processors are individually or collectively further operable to execute the code to cause the UE to:
receive an additional uplink grant scheduling one or more unused uplink slots of the time offset range; and
transmit an additional uplink message in accordance with the additional uplink grant in the one or more unused uplink slots.

24. The UE of claim 20, wherein the one or more processors are individually or collectively further operable to execute the code to cause the UE to:
transmit an indication of a preferred flexible time offset range.

25. A network entity, comprising:
one or more memories storing processor-executable code; and
one or more processors coupled with the one or more memories and individually or collectively operable to execute the code to cause the network entity to:
transmit configuration information that enables a user equipment (UE) to apply a flexible time offset between receipt of an uplink grant and transmission of an uplink message associated with the uplink grant;
transmit the uplink grant that indicates resources for transmission of the uplink message, wherein the uplink grant also indicates a time offset range that defines valid time durations for the flexible time offset; and
receive the uplink message in accordance with the flexible time offset that is within the time offset range.

26. The network entity of claim 25, wherein the one or more processors are individually or collectively further operable to execute the code to cause the network entity to:
receive a flexible time offset capability indicating that the UE is capable of applying the flexible time offset.

27. The network entity of claim 26, wherein the one or more processors are individually or collectively further operable to execute the code to cause the network entity to:
transmit a flexible time offset capability request, wherein the transmission of the flexible time offset capability is based at least in part on receiving the flexible time offset capability request.

28. The network entity of claim 25, wherein the one or more processors are individually or collectively further operable to execute the code to cause the network entity to:
receive an indication of a preferred flexible time offset range.

29. The network entity of claim 25, wherein the one or more processors are individually or collectively further operable to execute the code to cause the network entity to:
transmit an additional uplink grant scheduling one or more unused uplink slots of the time offset range; and
receive an additional uplink message in accordance with the additional uplink grant in the one or more unused uplink slots.
